(19) United States
(12) Patent Application Publication
(10) Pub. No.: US 2018/0068247 A1
(43) Pub. Date: Mar. 8, 2018

(54) SCHEDULE DISPLAYING METHOD, SCHEDULE DISPLAYING APPARATUS, AND COMPUTER-READABLE RECORDING MEDIUM

(71) Applicant: FUJITSU LIMITED, Kawasaki-shi (JP)

(72) Inventor: TAKUMA OKUDA, Kawasaki (JP)

(73) Assignee: FUJITSU LIMITED, Kawasaki-shi (JP)

(21) Appl. No.: 15/479,892

(22) Filed: Apr. 5, 2017

(30) Foreign Application Priority Data
Sep. 7, 2016 (JP) 2016-175070

(51) Int. Cl. G06Q 10/06

(52) U.S. Cl. CPC G06Q 10/06316; H04L 67/42; G06Q 10/0637

(57) ABSTRACT

A non-transitory computer-readable recording medium stores a schedule displaying program that causes a computer to execute a process including: registering, in a schedule, a specific task selected from among a plurality of kinds of tasks; acquiring, with reference to a memory that memorizes targeted values and past result values on performance of the tasks in association with the tasks, a targeted value and a past result value on performance of the specific task registered in the registering, the targeted value and the past result value corresponding to the specific task; and displaying, when displaying the schedule including the registered specific task, the schedule along with the targeted value and the past result value acquired in the acquiring.

### CROSS-REFERENCE TO RELATED APPLICATION

This application is based upon and claims the benefit of priority of the prior Japanese Patent Application No. 2016-175070, filed on Sep. 7, 2016, the entire contents of which are incorporated herein by reference.

### FIELD

The embodiments discussed herein are related to a schedule displaying method, a schedule displaying apparatus, and a computer-readable recording medium.

### BACKGROUND

There is used schedule managing software that manages a schedule. Such kind of schedule managing software registers various tasks, such as a preparation for a visit to a customer, a visit to a customer, and a plan of a telephone call to a customer, along with respective scheduled dates and times thereof.

Patent Document 1: Japanese Laid-open Patent Publication No. 2012-248072

However, in the related schedule managing software, while an operator can grasp the scheduled date and time of the registered task, it is difficult in some cases to grasp a working level such as difficulty of the registered task. For example, there exists a case where a goal is set for the task. For example, an insurance agent has a target number of telephone calls to customers and the like. The insurance agent can register, in the schedule managing software, scheduled dates and times of telephone calls to the customers, and can grasp the scheduled dates and times of the telephone calls. However, it is difficult to grasp the working level such as the number of the telephone calls. A telephone schedule of the insurance agent has been explained as an example. However, this problem universally occurs when a schedule management is performed on tasks having goals.

### SUMMARY

According to an aspect of the embodiments, a non-transitory computer-readable recording medium stores a schedule displaying program that causes a computer to execute a process including: registering, in a schedule, a specific task selected from among a plurality of kinds of tasks; acquiring, with reference to a memory that memorizes targeted values and past result values on performance of the tasks in association with the tasks, a targeted value and a past result value on performance of the specific task registered in the registering, the targeted value and the past result value corresponding to the specific task; and displaying, when displaying the schedule including the registered specific task, the schedule along with the targeted value and the past result value acquired in the acquiring.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a schematic configuration example of a scheduling system according to a first embodiment;

FIG. 2 is a diagram illustrating a configuration example of a server apparatus;

FIG. 3 is a diagram illustrating a data organization example of user information;

FIG. 4 is a diagram illustrating a data organization example of customer information;

FIG. 5 is a diagram illustrating a data organization example of telephonic communication information;

FIG. 6 is a diagram illustrating a data organization example of menu information;

FIG. 7 is a diagram illustrating a data organization example of main schedule information;

FIG. 8 is a diagram illustrating a data organization example of sub schedule information;

FIG. 9 is a diagram illustrating a data organization example of task information;

FIG. 10 is a diagram illustrating a data organization example of comparison result information;

FIG. 11 is a diagram illustrating a data organization example of automatic addition task information;

FIG. 12 is a diagram illustrating a data organization example of movement information;

FIGS. 13A to 13F are diagrams illustrating examples of a schedule screen;

FIG. 14A is a diagram illustrating a display example of a targeted value and a result value of a task;

FIG. 14B is a diagram illustrating a display example of a needed value of a task;

FIG. 14C is a diagram illustrating a display example of presence/absence of an undisplayed task;

FIGS. 14D and 14E are diagrams illustrating display examples of sub tasks;

FIG. 14F is a diagram illustrating one example of the schedule screen;

FIG. 15 a diagram illustrating a data organization example of the main schedule information to which tasks are automatically added;

FIGS. 16A to 16F are diagrams illustrating examples of the schedule screen;

FIG. 17A is a flowchart illustrating a processing procedure for task registering processes;

FIG. 17B is a flowchart illustrating a processing procedure for schedule displaying processes;

FIG. 17C is a flowchart illustrating a processing procedure for automatic registering processes; and

FIG. 18 is a diagram illustrating a computer that executes a schedule displaying program.

### DESCRIPTION OF EMBODIMENTS

Preferred embodiments will be explained with reference to accompanying drawings. In addition, the disclosed technology is not limited to the embodiments described below. Moreover, any of these embodiments may be appropriately combined within a consistent range.

### [a] First Embodiment

System Configuration

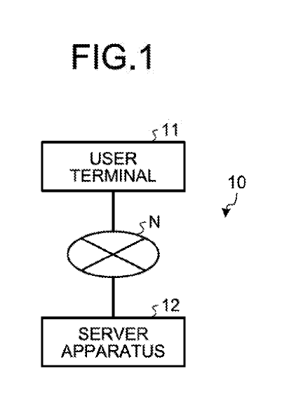

First, one example of a scheduling system 10 according to a first embodiment will be explained. FIG. 1 is a diagram illustrating a schematic configuration example of the scheduling system according to the first embodiment. As illustrated in FIG. 1, the scheduling system 10 includes a user terminal 11 and a server apparatus 12. In the present embodiment, the server apparatus 12 corresponds to a schedule displaying apparatus.

The scheduling system 10 is a system that manages a schedule of a user. In the present embodiment, the case where a schedule of an insurance agent as the user is managed will be explained as an example. The insurance agent visits a customer to do business and sales of insurance. The insurance agent performs various preparation operations for doing the business and the sales of the insurance in an office of an insurance company. The user terminal 11 is communicably connected with the server apparatus 12 through a network N. One mode of the network N can employ an arbitrary kind of a wired or wireless communication network such as a Local Area Network (LAN), a Virtual Private Network (VPN), and a mobile communication network.

The user terminal 11 is a device possessed by the insurance agent as the user. For example, the user terminal 11 is a mobile terminal device such as a smartphone and a tablet terminal. The insurance agent accesses the server apparatus 12 by using the user terminal 11, and registers a schedule of behaviors and results to manage a schedule.

The server apparatus 12 is a computer that provides, to the user, a scheduling service managing a schedule. The scheduling service may be provided by one computer, or by a computer system constituted of a plurality of computers. In the present embodiment, the case in which the scheduling service is provided by one server apparatus 12 will be explained as an example.

Server Apparatus

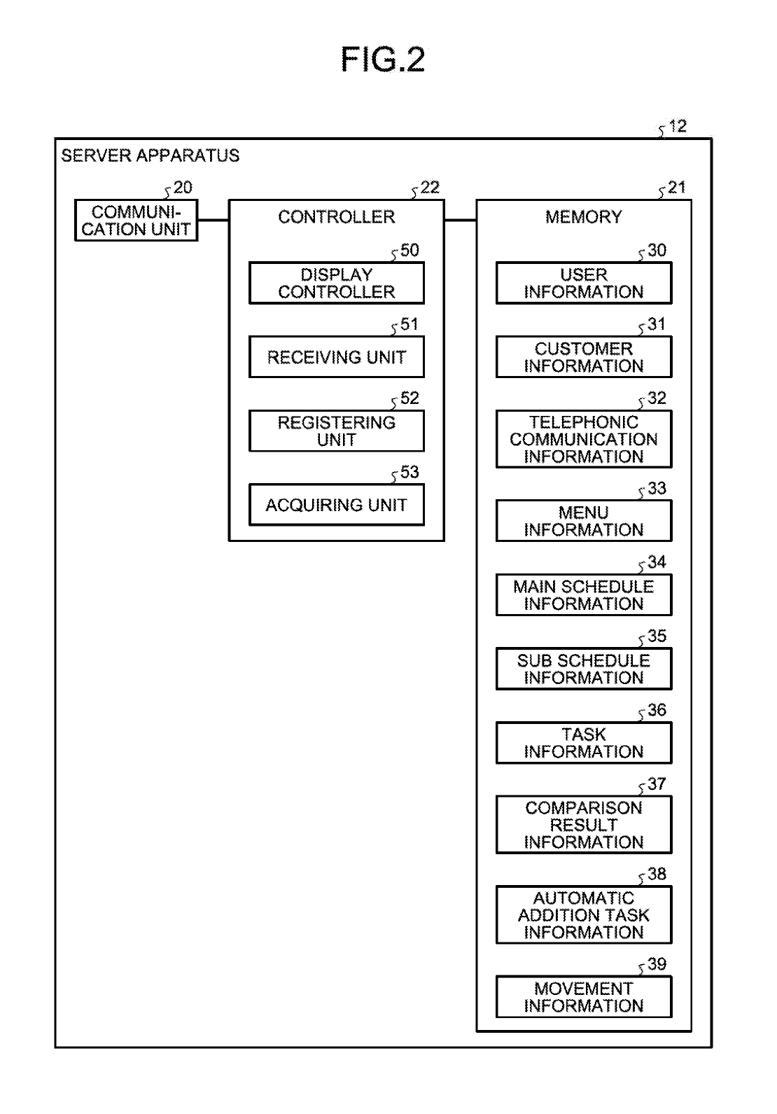

Next, a configuration of the server apparatus 12 according to the first embodiment will be explained. FIG. 2 is a diagram illustrating the configuration example of the server apparatus. As illustrated in FIG. 2, the server apparatus 12 includes a communication unit 20, a memory 21, and a controller 22.

The communication unit 20 is an interface that performs the communication control with anther device. The communication unit 20 sends and receives various kinds of information to and from anther device through the network N. The communication unit 20 may include a network interface card such as a LAN card.

The memory 21 is a memory device such as a hard disk, a Solid State Drive (SSD), and an optical disk. The memory 21 may be a rewritable semiconductor memory such as a Random Access Memory (RAM), a flash memory, and a Non-Volatile Static Random Access Memory (NVSRAM). Or the memory 21 may be an external server that performs memorization and provision of data.

The memory 21 memorizes various programs. The memory 21 memorizes various data to be used by the various programs. For example, the memory 21 memorizes user information 30, customer information 31, telephonic communication information 32, menu information 33, main schedule information 34, sub schedule information 35, task information 36, comparison result information 37, automatic addition task information 38, and movement information 39.

The user information 30 includes data that memorizes information on users performing the schedule management. In the present embodiment, information on the insurance agents, as the users performing the schedule management, is memorized in the user information 30.

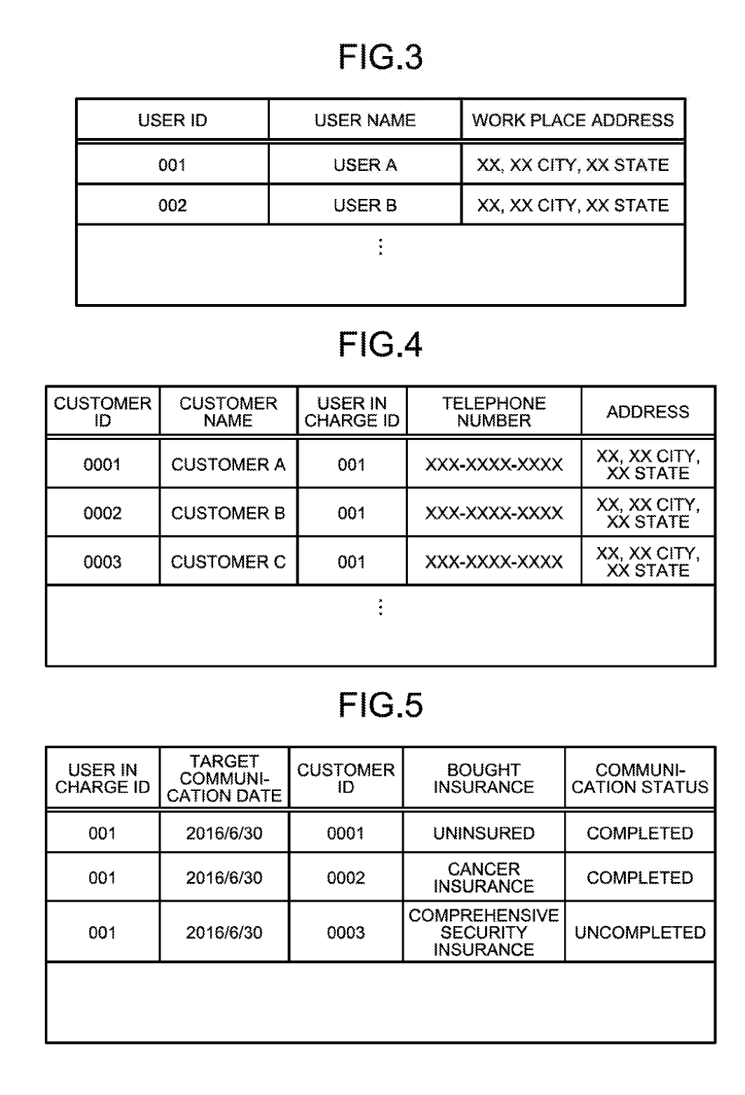

FIG. 3 is a diagram illustrating a data organization example of the user information. As illustrated in FIG. 3, the user information 30 includes items of “user ID”, “user name”, “work place address”, etc. Each of the items of the user information 30 illustrated in FIG. 3 is merely an example, and the user information 30 may include another item.

The item of the user ID is an area that memorizes identification information for identifying insurance agents. The unique user IDentifications (IDs) are given to the respective insurance agents as identification information. The user IDs given to the respective insurance agents are memorized in the item of the user ID. The item of the user name is an area that memorizes user names. The item of the work place address is an area that memorizes work place addresses where the respective insurance agents work. For example, the example illustrated in FIG. 3 indicates that the insurance agent whose user name is “user A” has the user ID of “001”, and has the work place address of “XX, XX City, XX State”.

The customer information 31 includes data that memorizes information on customers. In the present embodiment, information on customers to which the insurance agents sold insurances and customers to which the businesses of insurances are done is memorized in the customer information 31.

FIG. 4 is a diagram illustrating a data organization example of the customer information. As illustrated in FIG. 4, the customer information 31 includes items of “customer ID”, “customer name”, “user in charge ID”, “telephone number”, “address”, etc. Each of the items of the customer information 31 illustrated in FIG. 4 is merely an example, and the customer information 31 may include another item.

The item of the customer ID is an area that memorizes identification information identifying customers. The unique customer IDs are given to the respective customers as identification information. In the item of the customer ID, the customer IDs that are given to the respective customers are memorized. The item of the customer name is an area that memorizes customer names. The item of the user in charge ID is an area that memorizes user IDs of the insurance agents having charge of the customers. The item of the telephone number is an area that memorizes telephone numbers of the customers. The item of the address is an area that memorizes customer addresses. For example, the example illustrated in FIG. 4 indicates that the customer whose customer name is “customer A” has the customer ID of “0001”, the user ID (“001”) of the insurance agent having charge thereof, the telephone number of “XXX-XXXX-XXXX”, and the address of “XX, XX City, XX State”.

The telephonic communication information 32 includes data that memorizes information on the customers. In the present embodiment, information on target customers, on which the insurance agents are to perform the telephonic communication, is memorized in the telephonic communication information 32. The insurance agent is reported, from the company, a target customer, on which the telephonic communication is to be performed, such as a customer whose due date of the insurance is close. For example, a system of the insurance company extracts the target customers, on which the telephonic communication is to be performed by the respective insurance agents, to generate the telephonic communication information 32, and the generated telephonic communication information 32 is stored in the memory 21.

FIG. 5 is a diagram illustrating a data organization example of the telephonic communication information. As illustrated in FIG. 5, the telephonic communication information 32 includes items of “user in charge ID”, “target communication date”, “customer ID”, “bought insurance”, “communication status”, etc. Each of the items of the telephonic communication information 32 illustrated in FIG. 5 is merely an example, and the telephonic communication information 32 may include another item.

The item of the user in charge ID is an area that memorizes user IDs of the respective insurance agents having charge of the telephonic communication. The item of the target communication date is an area that memorizes target dates when the telephonic communications with the customers are to be performed. The item of the customer ID is an area that memorizes customer IDs of the customers to be communicated with. The item of the bought insurance is an area that memorizes insurances bought by the customers. The item of the communication status is an area that memorizes statuses of the telephonic communications. For example, the example illustrated in FIG. 5 indicates that the insurance agent whose user in charge ID is “001” has the customers, whose customer IDs are “0001”, “0002”, and “0003”, to be communicated with by telephone on Jun. 30, 2016. The example illustrated in FIG. 5 also indicates that the insurance of the customer whose customer ID is “0001” is not bought, and the telephonic communication therewith has completed.

The menu information 33 includes data that memorizes information on a menu to be displayed when a schedule is registered. In the present embodiment, various behaviors are memorized in the menu information 33, which are to be performed as tasks by the insurance agent that can register, in the schedule, a preparation for a visit to the customer, a visit to the customer, a plan of a telephone call to a customer, etc.

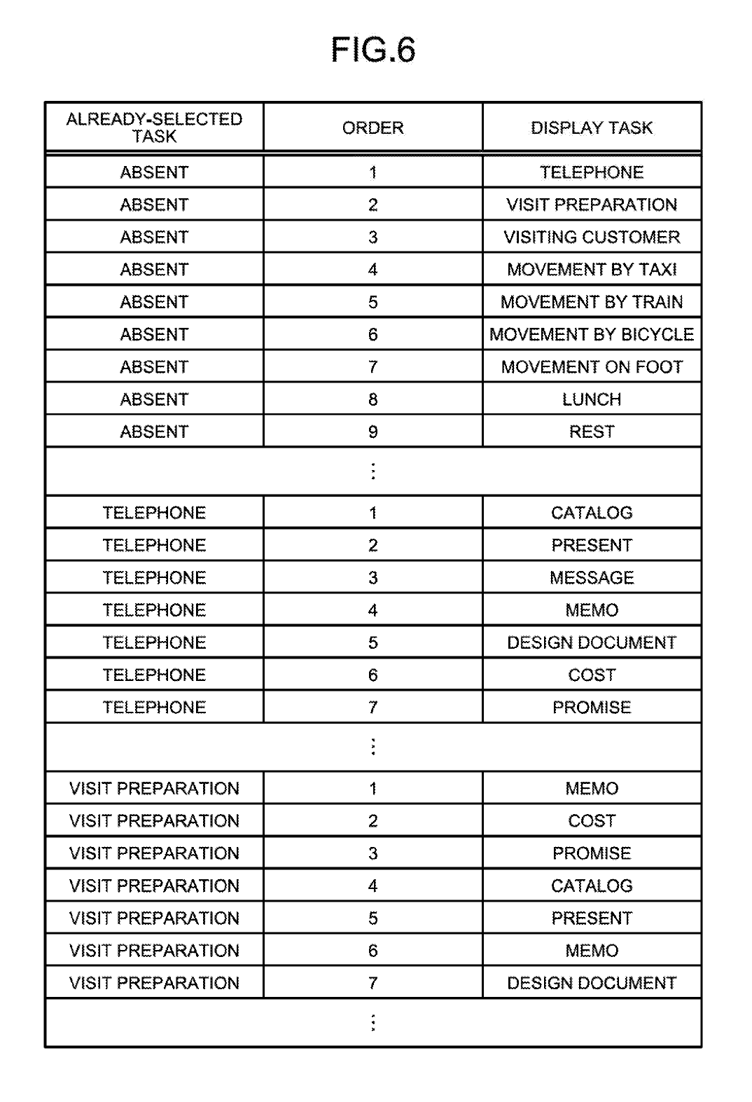

FIG. 6 is a diagram illustrating a data organization example of the menu information. As illustrated in FIG. 6, the menu information 33 includes items of “already-selected task”, “order”, “display task”, etc. Each of the items of the menu information 33 illustrated in FIG. 6 is merely an example, and the menu information 33 may include another item.

The item of the already-selected task is an area that memorizes tasks that are selected in registration of the schedule. The item of the order is an area that memorizes the order of tasks to be displayed in the menu. The item of the display task is an area that memorizes tasks to be displayed in the menu. Herein, in registering the schedule according to the present embodiment, the task to be next displayed in the menu is changed in accordance with the task selected in the menu. In the menu information 33, a task to be displayed in the menu is registered so that the task, whose frequency of attending a selected task is high, is displayed in the menu in accordance with the task selected in the menu. For example, in the menu information 33, the task to be displayed in the menu when any task is not selected in registering the schedule is registered so that the item of the already-selected task is “absent”. In the menu information 33, the task to be displayed in the menu when the task is selected in registering the schedule is registered so that the item of the already-selected task is an already selected task. For example, in the example illustrated in FIG. 6, each of the tasks for “telephone”, “visit preparation”, etc. is stored as the task to be displayed, in the menu, when any task is not selected in registering the schedule. In the example illustrated in FIG. 6, each of tasks for “catalog”, “present”, etc. is stored as the task to be displayed, in the menu, when “telephone” is selected in registering the schedule.

The main schedule information 34 and the sub schedule information 35 include data that memorizes information on tasks whose schedule are registered. Herein, the task registered in the schedule by the insurance agent is attended in some cases by a task associated with this registered task. In the present embodiment, the task, which is a subject of each of the times in the schedule, is managed as the main task, and the task, which attends in association with the main task, is managed as the sub task. The main schedule information 34 memorizes information on the main tasks registered in the schedule. The sub schedule information 35 memorizes information on the sub tasks registered in the schedule.

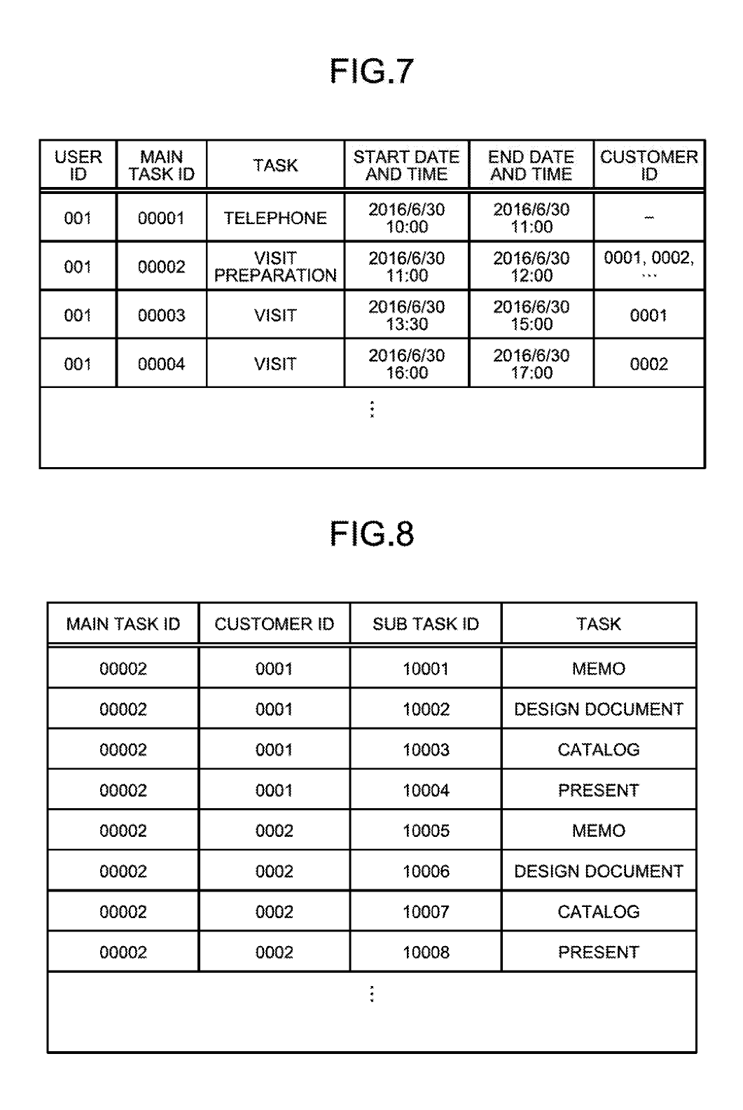

FIG. 7 is a diagram illustrating a data organization example of the main schedule information. As illustrated in FIG. 7, the main schedule information 34 includes items of “user ID”, “main task ID”, “task”, “start date and time”, “end date and time”, “customer ID”, etc. Each of the items of the main schedule information 34 illustrated in FIG. 7 is merely an example, and the main schedule information 34 may include another item.

The item of the user ID is an area that memorizes user IDs of the insurance agents registering the tasks. The item of the main task ID is an area that memorizes identification information that identifies the subject tasks registered in the schedule. When the insurance agent registers the task in the schedule, the unique task ID is given to the registered task as the identification information that identifies the registered task. In the item of the main task ID, the task IDs of the subject tasks registered in the schedule are stored. The item of the task is an area that memorizes kinds of the subject tasks registered in the schedule. The item of the start date and time is an area that memorizes start dates and times of the subject tasks registered in the schedule. The item of the end date and time is an area that memorizes end dates and times of the subject tasks registered in the schedule. The item of the customer ID is an area that memorizes customer IDs of the target customers of the subject tasks registered in the schedule. When the subject task registered in the schedule is an operation for the specific customer, the customer ID of the specific customer is stored in the item of the customer ID, and when the subject task registered in the schedule is not the operation for the specific customer, “-” is stored therein. For example, the example illustrated in FIG. 7 indicates that a task for “telephone” whose task ID is “00001” is registered, from 10 a.m., 30 Jun. 2016 to 11 a.m., 30 Jun. 2016, in the schedule of the insurance agent whose user ID is “001”. The item of the customer ID corresponding to the task for “telephone” is “-”, and that the task is not an operation for the specific customer is indicated.

FIG. 8 is a diagram illustrating a data organization example of the sub schedule information. As illustrated in FIG. 8, the sub schedule information 35 includes items of “main task ID”, “customer ID”, “sub task ID”, “task”, etc. Each of the items of the sub schedule information 35 illustrated in FIG. 8 is merely an example, and the sub schedule information 35 may include another item.

The item of the main task ID is an area that memorizes task IDs of the main tasks associate with the sub tasks. The item of the customer ID is an area that memorizes customer IDs of the target customers of the sub tasks. When the sub task is an operation for the specific customer, the customer ID of the specific customer is stored in the item of the customer ID, and when the sub task is not the operation for the specific customer, “-” is stored therein. The item of the sub task ID is an area that memorizes task IDs of the sub tasks registered in association with the main tasks. The item of the task is an area that memorizes kinds of the sub tasks registered in association with the main tasks. For example, the example illustrated in FIG. 8 indicates that a task for “memo” whose task ID is “10001” is registered in the schedule in association with the main task whose task ID is “00002”.

The task information 36 includes data that memorizes information on the tasks registered in the schedule. In the present embodiment, information on the main and the sub tasks registered in the schedule is memorized in the task information 36.

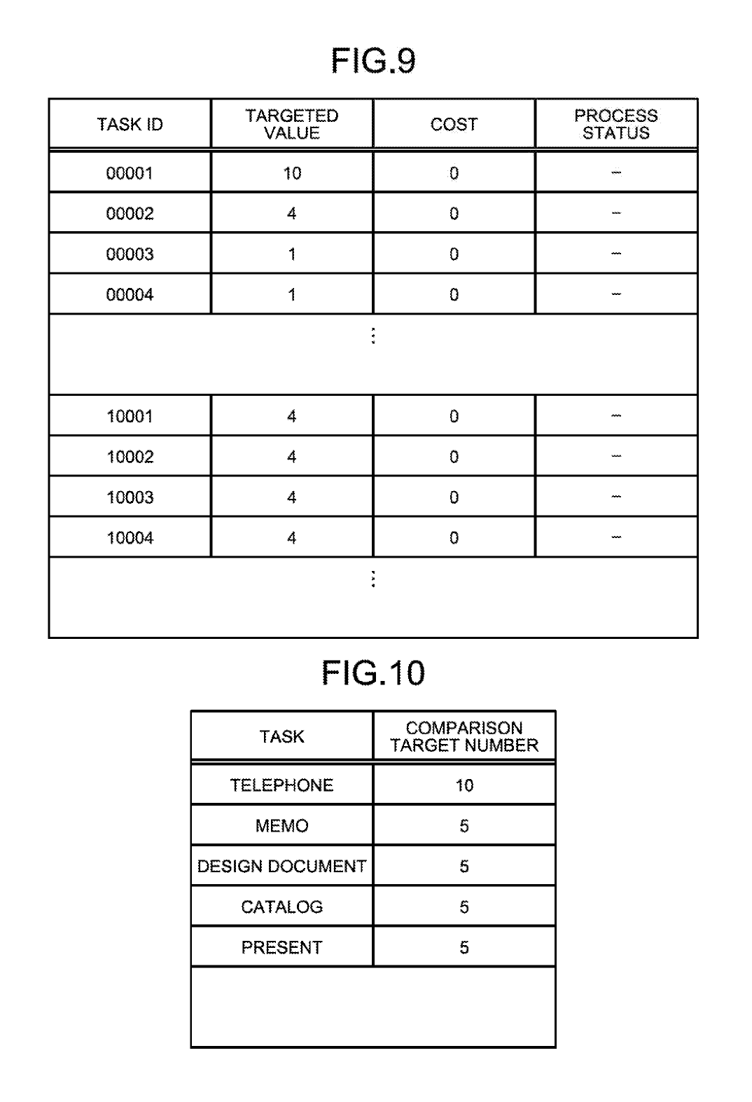

FIG. 9 is a diagram illustrating a data organization example of the task information. As illustrated in FIG. 9, the task information 36 includes items of “task ID”, “targeted value”, “cost”, “process status”, etc. Each of the items of the task information 36 illustrated in FIG. 9 is merely an example, and the task information 36 may include another item.

The item of the task ID is an area that memorizes task IDs of the main and the sub tasks registered in the schedule. The item of the targeted value is an area that memorizes target numbers of the respective tasks to be processed by the insurance agent among the registered main and sub tasks. The target number of the task may be decided for each kind of the task, or may be registered by the insurance agent. In the item of the targeted value, the target numbers are stored. The item of the cost is an area that memorizes the costs generated by the respective registered main and sub tasks. The item of the process status is an area that memorizes process statuses of the respective registered main and sub tasks. When the operation of the task is not processed, “-” is stored in the item of the process status, and when the operation of the task is completed, “already done” is stored. For example, the example illustrated in FIG. 9 indicates that the target number of the task is “10” with respect to the task whose task ID is “00001”, the generated cost is “0” yen, and the operation is not processed.

The comparison result information 37 includes data that memorizes information on results that are respective comparison targets of the tasks. In the present embodiment, when the insurance agent registers the task, the result as the comparison target is displayed for the registered task. The result as the comparison target may be a past result of the insurance agent that is the same as the insurance agent of the logged-in user ID, or may be a past result of another insurance agent. For example, the comparison result information 37 may memorize the average of results, in a predetermined past time period, of the insurance agent of the logged-in user ID. For example, the comparison result information 37 may memorize, as a sample, results of the tasks of the insurance agent whose business performance is excellent.

FIG. 10 is a diagram illustrating a data organization example of the comparison result information. As illustrated in FIG. 10, the comparison result information 37 includes items of “task”, “comparison target number”, etc. Each of the items of the comparison result information 37 illustrated in FIG. 10 is merely an example, and the comparison result information 37 may include another item.

The item of the task is an area that memorizes kinds of the tasks as the comparison targets. The comparison target number is an area that memorizes numbers of processed results of the tasks as the comparison targets. For example, the example illustrated in FIG. 10 indicates that the number of processed results as the comparison target is “10” with respect to a task for telephone.

The automatic addition task information 38 includes data that memorizes information on the tasks that can be automatically added. Herein, in some cases, the insurance agent registers, in the schedule, an important task such as the task associated with the customer, however, does not registers therein an arbitrary task such as the task associated with the insurance agent him/herself. Therefore, in the present embodiment, a predetermined arbitrary task performed regularly can be automatically added to the schedule.

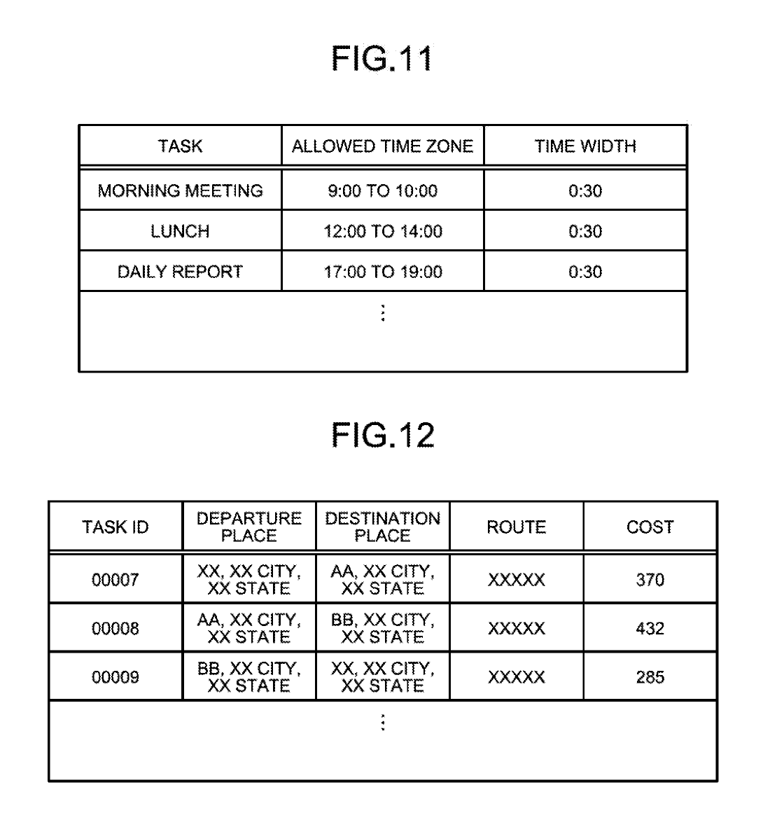

FIG. 11 is a diagram illustrating a data organization example of the automatic addition task information. As illustrated in FIG. 11, the automatic addition task information 38 includes items of “task”, “allowed time zone”, “time width”, etc. Each of the items of the automatic addition task information 38 illustrated in FIG. 11 is merely an example, and the automatic addition task information 38 may include another item.

The item of the task is an area that memorizes kinds of the tasks that can be automatically added. The item of the allowed time zone is an area that memorizes time zones that allow the tasks to be added. The item of the time width is an area that memorizes the times of the time widths needed by the respective tasks. For example, the example illustrated in FIG. 11 indicates that a task for morning meeting can be automatically added when there exists an unoccupied time for thirty minutes in the time zone from nine o'clock to ten o'clock.

The movement information 39 includes data that memorizes information on the tasks for movements. Herein, the insurance agent moves in order to, for example, visit a customer. The movement information 39 memorizes information on the movement tasks such as visits to the customers.

FIG. 12 is a diagram illustrating a data organization example of the movement information. As illustrated in FIG. 12, the movement information 39 includes items of “task ID”, “departure place”, “destination place”, “route”, “cost”, etc. Each of the items of the movement information 39 illustrated in FIG. 12 is merely an example, and the movement information 39 may include another item.

The item of the task ID is an area that memorizes task IDs of the movement tasks. The item of the departure place is an area that memorizes departure places of movements. The item of the destination is an area that memorizes destination places of the movements. The item of the route is an area that memorizes movement routes between the respective departure places and destination places. The item of the cost is an area that memorizes costs of the movements from the respective departure places to the destination places. For example, the example illustrated in FIG. 12 indicates that the departure place of the movement task, whose task ID is “00007”, is “XX, XX City, XX State”, the destination thereof is “XX, XX City, XX State”, the movement route thereof is “XXXXX”, and the cost thereof is “370” yen.

The controller 22 is a device that controls the server apparatus 12. As the controller 22, an electronic circuit such as a Central Processing Unit (CPU) and a Micro Processing Unit (MPU); an integrated circuit such as an Application Specific Integrated Circuit (ASIC) and a Field Programmable Gate Array (FPGA); etc. can be employed. The controller 22 includes an internal memory that stores control data and programs deciding various processing procedures so as to execute various processes by using them. The controller 22 functions as various processing units by operations of various programs. For example, the controller 22 includes a display controller 50, a receiving unit 51, a registering unit 52, and an acquiring unit 53.

The display controller 50 controls to display various kinds of information. For example, when accepting an access from the user terminal 11, the display controller 50 sends information on various operation screens to the user terminal 11 as an access source so as to perform the control of causing the user terminal 11 as the access source to display the operation screen. For example, the display controller 50 causes the user terminal 11 to display a login screen in response to an access from the user terminal 11 so as to accept a login by an input of the user ID. When the login succeeds, the display controller 50 performs the control of causing the user terminal 11 to display the various screens including the operation screen. For example, the display controller 50 causes the user terminal 11 to display a schedule screen indicating the schedule of the insurance agent of the input user ID.

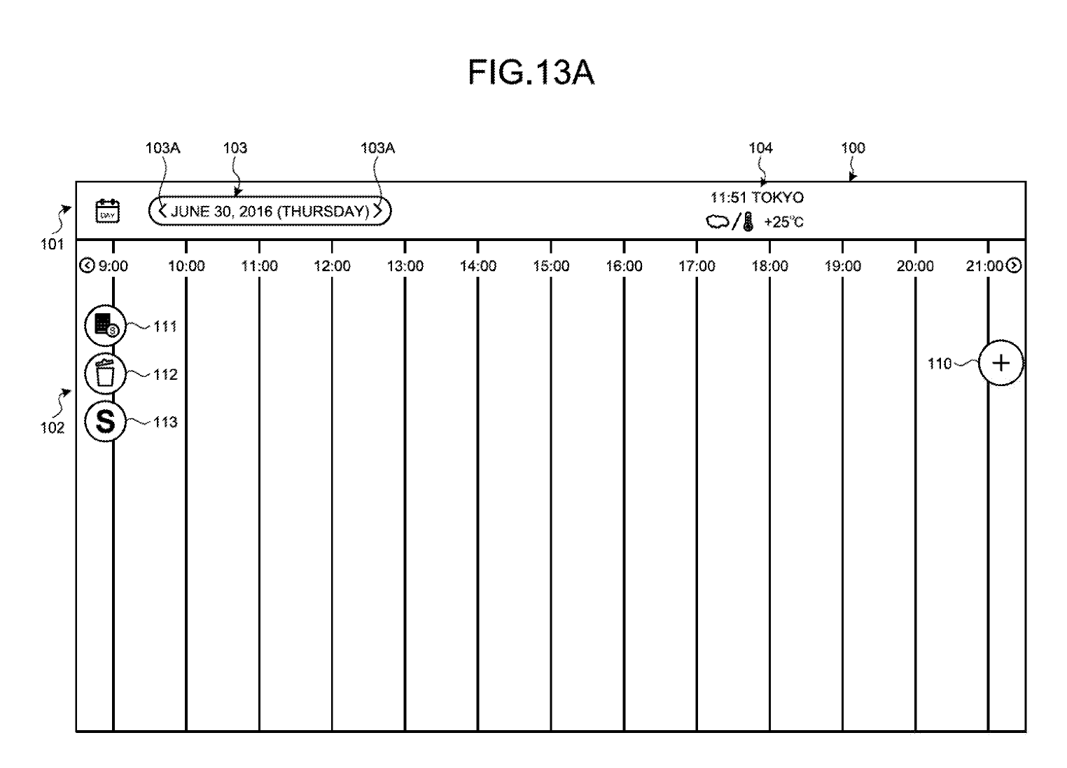

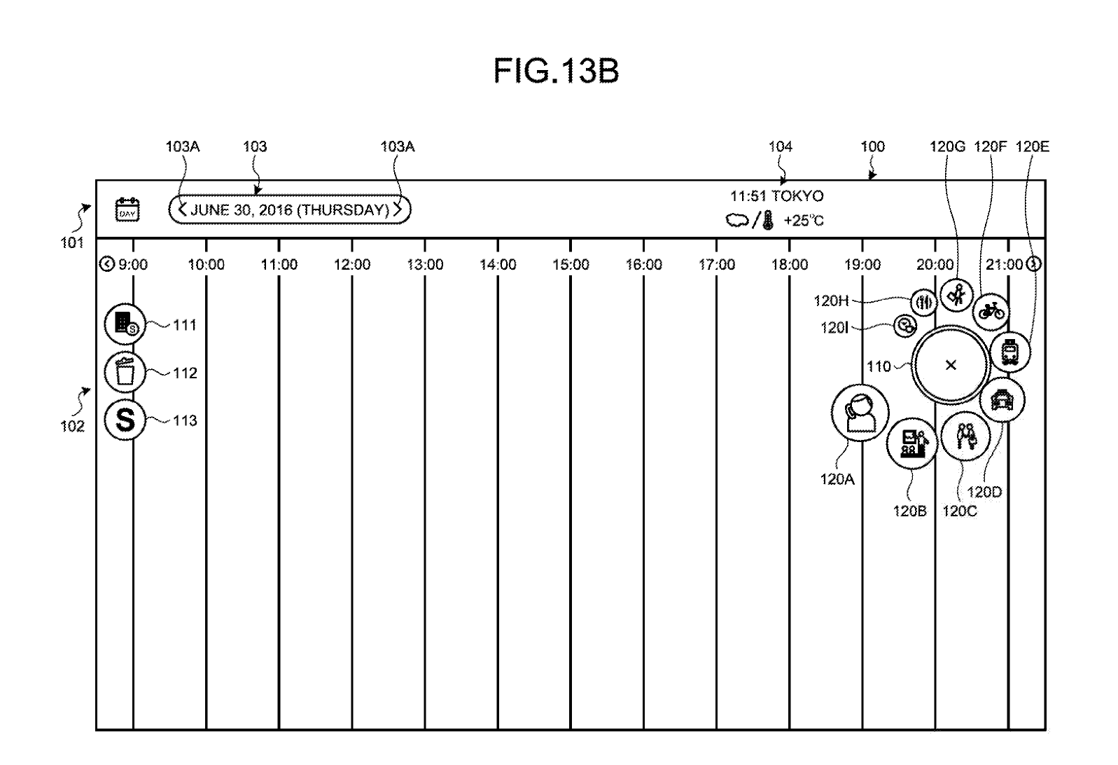

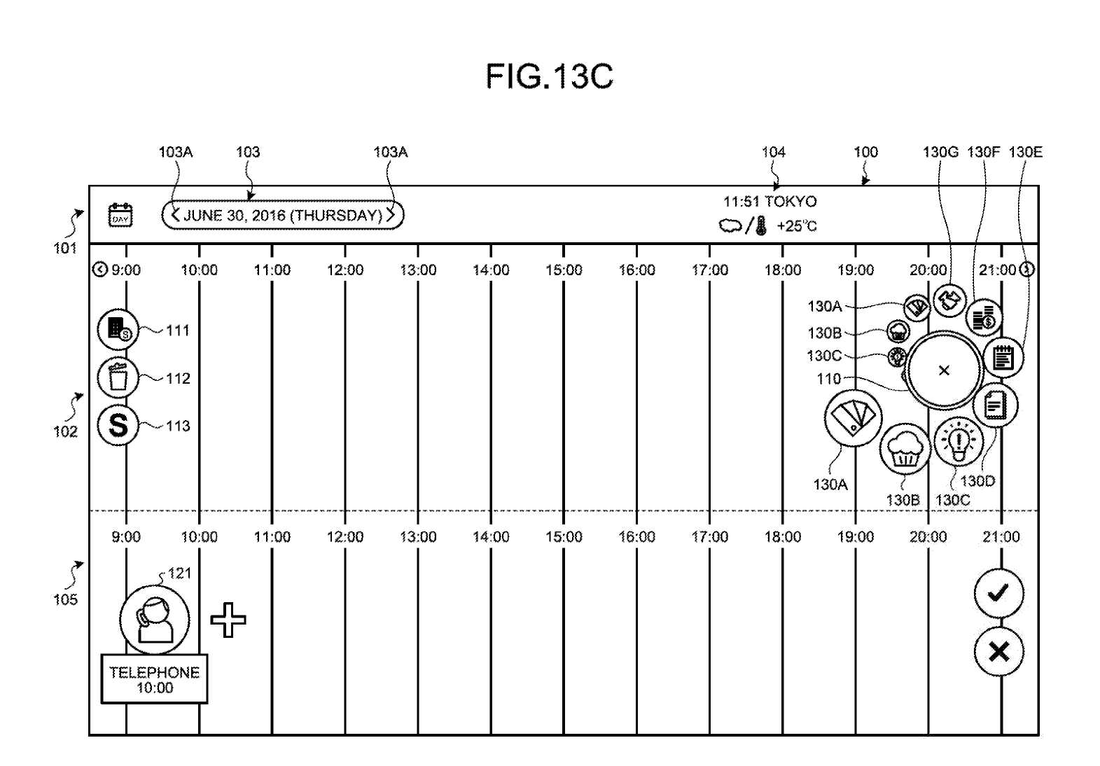

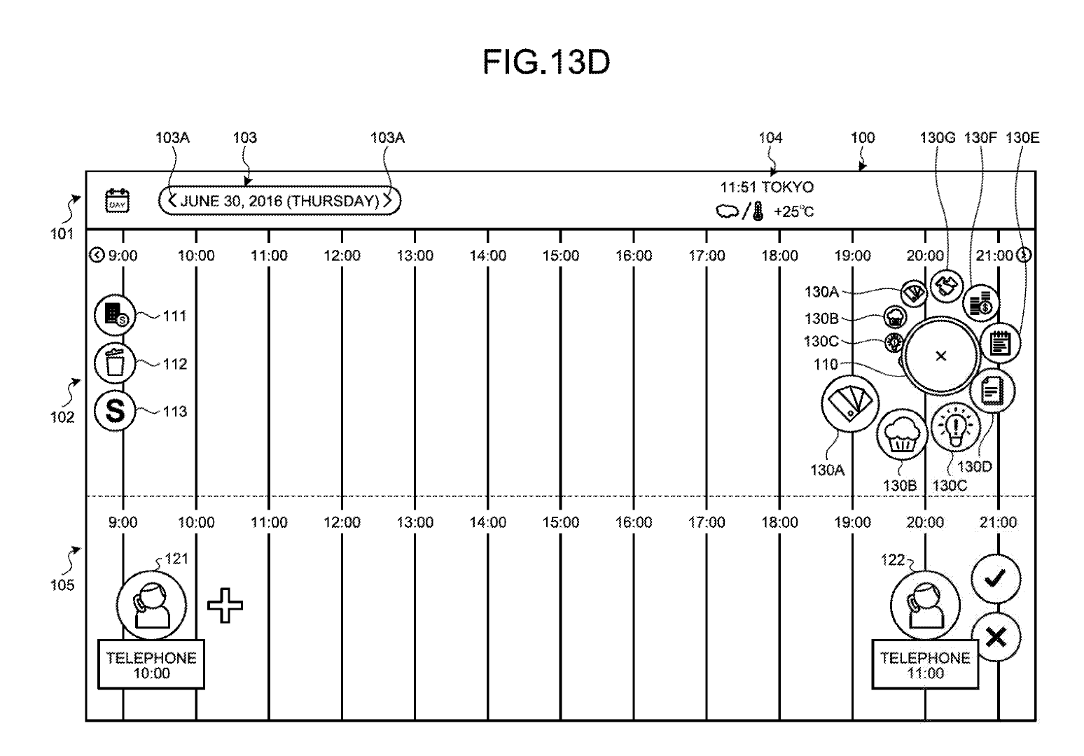

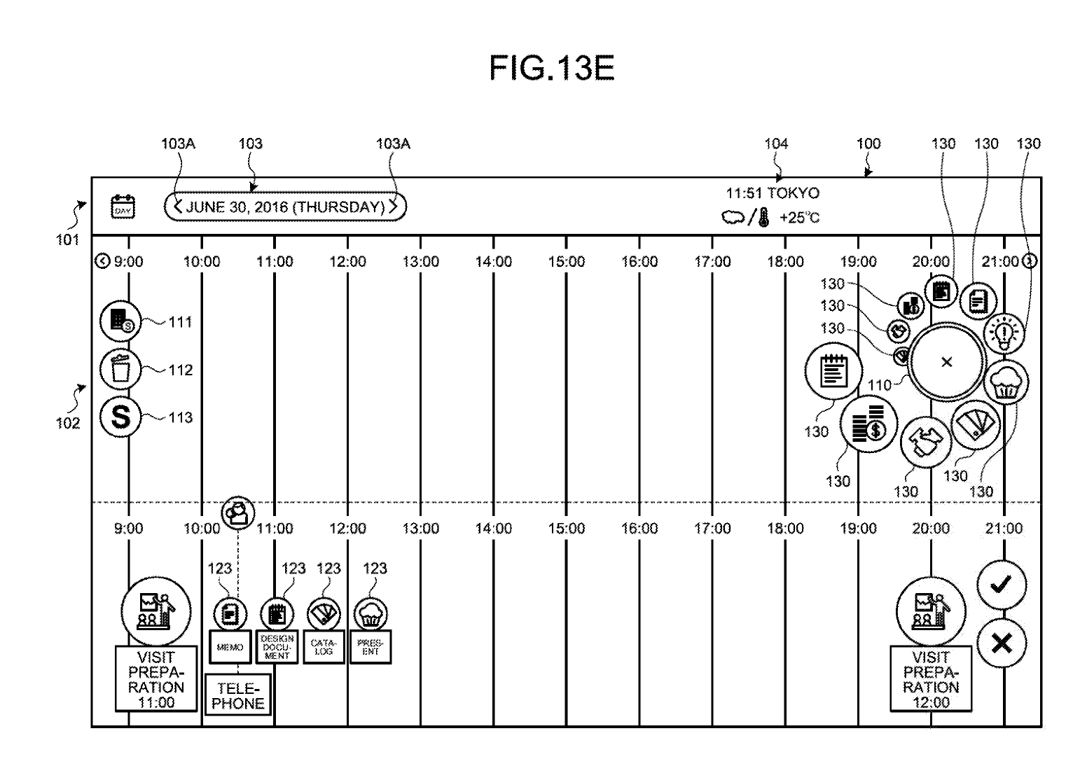

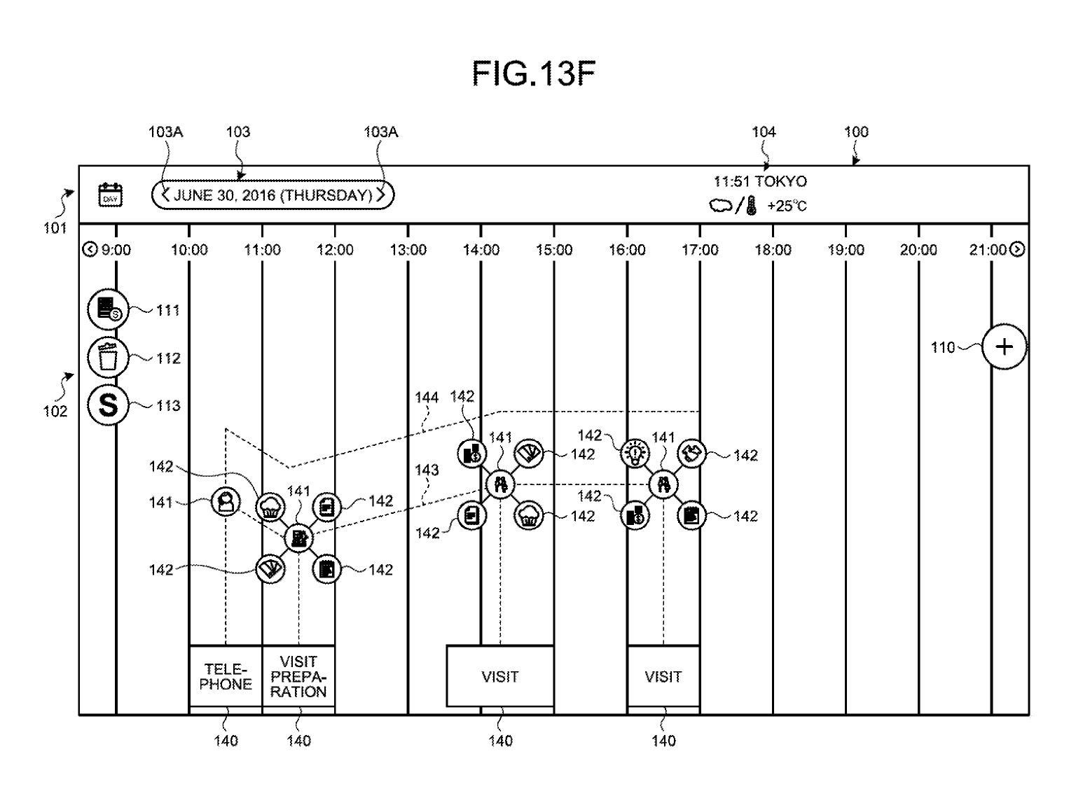

FIG. 13A is a diagram illustrating one example of the schedule screen. The example illustrated in FIG. 13A indicates that one example of the schedule screen to be displayed on the user terminal 11. A schedule screen 100 includes a header area 101 that is arranged in the upper part of the schedule screen 100 and a main area 102 that displays the schedule. In the header area 101, a date area 103 that displays the date and a weather displaying area 104 that displays weather information are arranged.

In the date area 103, the date of the log-in day is displayed as an initial display. In the date area 103, switching icons 103A are arranged in the respective right and left sides of the date, and the displayed date can be changed by using the switching icons 103A. In the main area 102, the schedule of the date displayed in the date area 103 is displayed. The insurance agent operates the switching icons 103A to change the displayed date, so that it is possible to check the schedule of the past or future date.

In the weather displaying area 104, weather information corresponding to a position of the user terminal 11 is displayed. For example, the display controller 50 acquires position information of the user terminal 11 from the user terminal 11, and causes the user terminal 11 to display the weather information corresponding to the position of position information of the user terminal 11 at the weather displaying area 104 by using an external server that provides the weather information.

In the main area 102, the time is chronologically displayed in the lateral direction to express a flow of the time. A menu icon 110, a cost icon 111, a recycle bin icon 112, and a simulation icon 113 are arranged in the main area 102.

The menu icon 110 is an icon that gives an instruction of displaying tasks that can be registered in the schedule. The cost icon 111 is an icon that gives an instruction of displaying generated cost. The recycle bin icon 112 is an icon that deletes a task. In the present embodiment, the task to be deleted is deleted from the schedule by moving the task to be deleted to the recycle bin icon 112 while keeping the selected state and then canceling the selection. The simulation icon 113 is an icon that gives an instruction of addition of a task that can be automatically added to the schedule.

The receiving unit 51 receives various operations. For example, the receiving unit 51 receives various kinds of operation information on the operation screen from the user terminal 11 to accept the various operations. For example, the receiving unit 51 receives various operations associated with the schedule in response to operations on the schedule screen 100. For example, the receiving unit 51 receives a display instruction of a task, which can be registered in the schedule, by a selecting operation of the menu icon 110 on the schedule screen 100.

When receiving a selecting operation of the menu icon 110, the display controller 50 causes the schedule screen 100 to display a task, which can be added to the schedule, based on the menu information 33.

FIG. 13B is a diagram illustrating one example of the schedule screen. The example illustrated in FIG. 13B indicates a state where a selecting operation is performed on the menu icon 110. For example, as illustrated in FIG. 13B, when any task is not selected, the display controller 50 reads, from the menu information 33, tasks whose items of the already-selected tasks are “absent”. The display controller 50 controls to display icons 120 (120A to 120I), which indicate the read tasks, around the menu icon 110 in accordance with the order thereof. The icon 120A indicates a task for telephone. The icon 120B indicates a task for visit preparation. The icon 120C indicates a task for visiting customer. The icon 120D indicates a movement by taxi. The icon 120E indicates a movement by train. The icon 120F indicates a movement by bicycle. The icon 120G indicates a movement on foot. The icon 120H indicates a task for lunch. The icon 120I indicates a task for rest.

The receiving unit 51 receives selection of a task to be added to the schedule. For example, the receiving unit 51 receives selection of a task to be added to the schedule from among the plurality of kinds of tasks by the selecting operation to the icons 120A to 120I in the schedule screen 100. The receiving unit 51 receives specifying of start and end times of the task to be added to the schedule. For example, the receiving unit 51 receives specifying of start and end times by moving an icon of a task to be added to the schedule, which is turned to a selected state, to respective positions of the times.

For example, when adding a task to the schedule, the insurance agent moves the task to be added to the position of the start time while keeping the selected state thereof, and then cancels the selection. FIG. 13C is a diagram illustrating one example of the schedule screen. The example illustrated in FIG. 13C indicates a state where an operation for moving the icon 120A to a position of ten o'clock while keeping the selected state thereof is performed, and a task for telephone is added to the schedule to set the start time to be ten o'clock. The display controller 50 controls to display, in a lower half part of the main area 102, a sub area 105 in which setting of the added task is performed. In the sub area 105, the time is also chronologically displayed in the lateral direction. In the example illustrated in FIG. 13C, the start time of ten o'clock is displayed in the sub area 105 along with the icon 121 of the task for telephone.

The end time of the added task can be specified in the sub area 105. Moreover, a task, which is to attend this added task in association with each other, can be specified in the sub area 105. When a task is selected from the menu icon 110 and is added thereto, the display controller 50 controls to display the task, whose frequency of attending the added task in association with each other is high, as a task that can be added. For example, as illustrated in FIG. 13C, when a task for telephone is selected, the display controller 50 reads, from the menu information 33, the tasks whose items of the already-selected tasks are “telephone”. The display controller 50 controls to display icons 130 (130A to 130G), which indicate the read tasks, around the menu icon 110 in accordance with the order thereof. The icon 130A indicates the task for preparing an insurance catalog. The icon 130B indicates a task for preparing a present. The icon 130C indicates a task for registering contents to be reported to a customer. The icon 130D indicates a task for registering contents of a memo. The icon 130E indicates a task for preparing a design document of the insurance. The icon 130F indicates a task for registering the cost. The icon 130G indicates a task for registering contents promised with a customer.

When specifying the end time of the added task, the insurance agent moves the icon 121 displayed in the sub area 105 to the position of the end time while keeping the selected state thereof, and then cancels the selection. FIG. 13D is a diagram illustrating one example of the schedule screen. The example illustrated in FIG. 13D indicates a state where an operation for moving the icon 121 to a position of eleven o'clock is performed while keeping the selected state thereof, and the end time of the task for telephone is specified to be eleven o'clock. The display controller 50 controls to display the end time of eleven o'clock in the sub area 105 along with the icon 122 of the task for telephone.

When associating an attending task with a task added to the schedule, the insurance agent moves the task to be attending to a position in the sub area 105 while keeping the selected state thereof, and the cancels the selection. FIG. 13E is a diagram illustrating one example of the schedule screen. The example illustrated in FIG. 13E indicates a state where each of the tasks for “memo”, “design document”, “catalog”, and “present” is associated with a task for “visit preparation”. The display controller 50 controls to display the icons 123 of the tasks for “memo”, “design document”, “catalog”, and “present”.

When the receiving unit 51 receives addition of a task to the schedule, the registering unit 52 registers the added task in the memory 21. For example, when a main task is added, the registering unit 52 gives a unique task ID to the added main task. The registering unit 52 registers, in the main schedule information 34, a user ID of the insurance agent that registered the task, a task ID of the added main task, the main task, start date and time of the main task, and end date and time of the main task. When a target customer of the main task is specified, the registering unit 52 registers, in the main schedule information 34, a customer ID of the target customer of the task, and when any target customer of the main task is not specified, the registering unit 52 registers a customer ID, as “-”, in the main schedule information 34. The specifying of the target customer will be mentioned later. The registering unit 52 registers a record in the task information 36 by using the task ID of the added main task.

For example, when a sub task is added, the registering unit 52 gives a unique task ID to the added sub task. The registering unit 52 registers, in the sub schedule information 35, a task ID of the main task associated with the added sub task, the task ID of the sub task, and the sub task. When a target customer of the sub task is specified, the registering unit 52 registers, in the sub schedule information 35, the sub task for each customer ID of the target customer of the task, and when any target customer is not specified, the registering unit 52 sets “-” for the customer ID, and registers the sub task in the sub schedule information 35. Thus, when the sub task is added, the main task and each sub task are memorized, as the schedule, in the memory 21 in association with each other.

When the main area 102 is selected after the task is registered in the schedule on the schedule screen 100, the display controller 50 displays already-registered tasks in the main area 102. For example, the display controller 50 controls to display already-registered main tasks. When a sub task, which attends a main task, is registered, the display controller 50 displays the sub task in association with the main task. FIG. 13F is a diagram illustrating one example of the schedule screen. The example illustrated in FIG. 13F indicates a state where “telephone”, “visit preparation” and two “visits” are registered as main tasks. The display controller 50 displays a schedule bar, which displays a bar 140, in which an appellation corresponding to the main task is presented and whose position and length correspond to a time zone of the main task for each of the registered main tasks. For example, the display controller 50 displays the bar 140 at a time range in the main area 102 corresponding to the start and the end dates and times of the main task. The display controller 50 controls to display an icon 141 of the main task associated with the bar 140 for each of the main tasks. When there is registered a sub task attending the main task, the display controller 50 controls to display an icon 142 of the attending sub task around the icon 141 of the main task.

For a task registered in the schedule, a target processed number (target number) of task to be performed by the insurance agent can be set as a targeted value. The target number of task may be automatically set by using past results of the insurance agent, may be set by using a fixed value, or may be registered by the insurance agent. For example, each target number of the task may be an average value or a maximum value of results in a predetermined past time period of the insurance agent with respect to the same kind of task. The insurance agent may register each target number of task by displaying, in registering the corresponding task, an operation screen to which values can be input such as a software keyboard. The registering unit 52 registers a target number of task in the task information 36.

In the present embodiment, the icons 141 of respective main tasks are displayed in the schedule screen 100 at heights according to the goals.

The acquiring unit 53 acquires various kinds of information. For example, the acquiring unit 53 acquires a target number of a main task from the task information 36 for each of main tasks. When a sub task is registered in association with the main task, the acquiring unit 53 also acquires a target number of the sub task associated with the main task from the task information 36.

The display controller 50 performs, for each of main tasks, weight addition on a target number of the corresponding main task by adding thereto a predetermined weight according to a kind of the corresponding main task so as to calculate a targeted value of the corresponding main task. The display controller 50 controls to display the icons 141 of the main tasks at respective heights in accordance with the computed targeted values. The example illustrated in FIG. 13F indicates a line 143 that connects the icons 141 of the main tasks at respective heights according to the targeted values.

In the present embodiment, past results of main tasks are displayed on the schedule screen 100.

For example, the acquiring unit 53 acquires from the comparison result information 37, for each of the main tasks, the number of processed results that is a comparison target of the corresponding main task. When a sub task is registered in association with the main task, the acquiring unit 53 also acquires, from the comparison result information 37, the number of processed results that is a comparison target of the sub task associated with the main task.

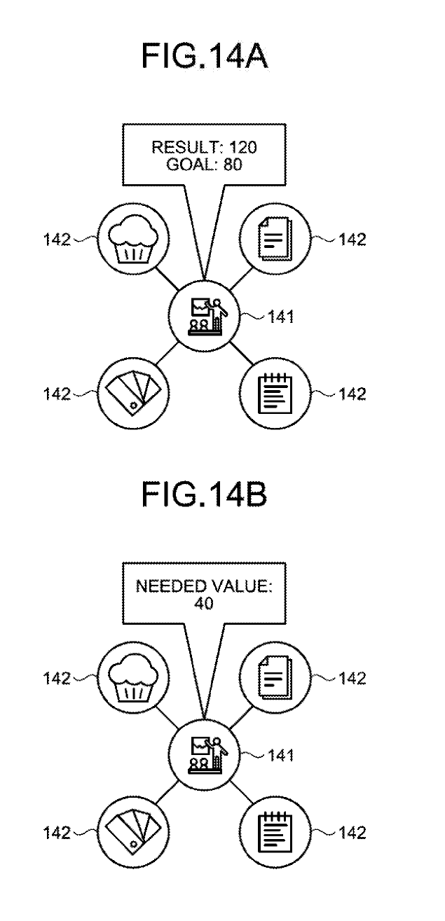

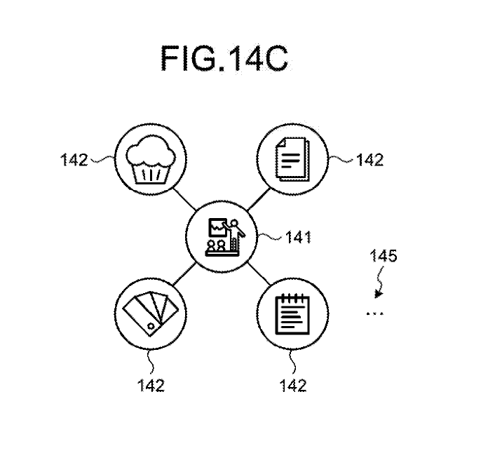

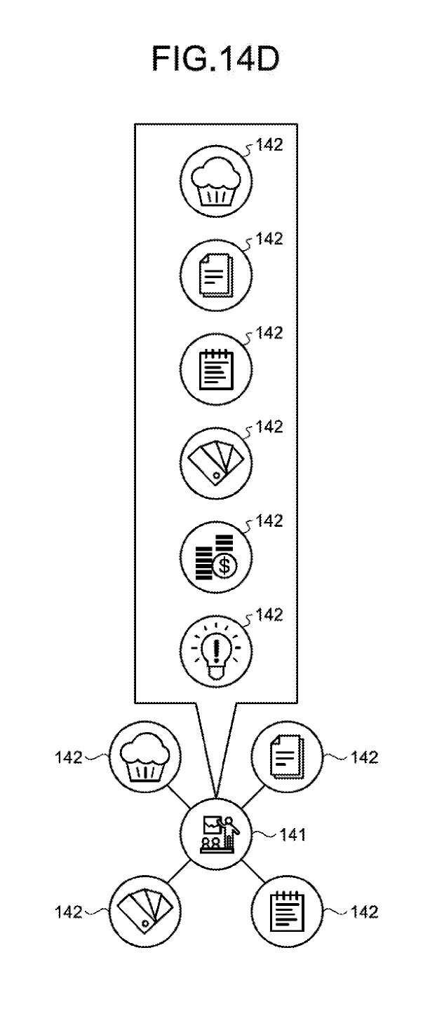

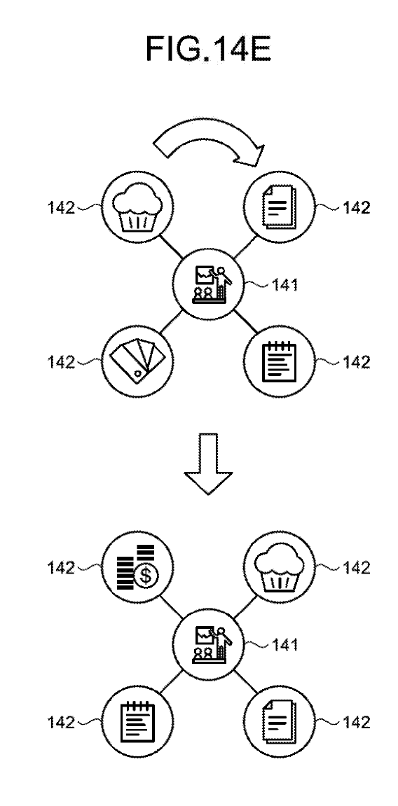

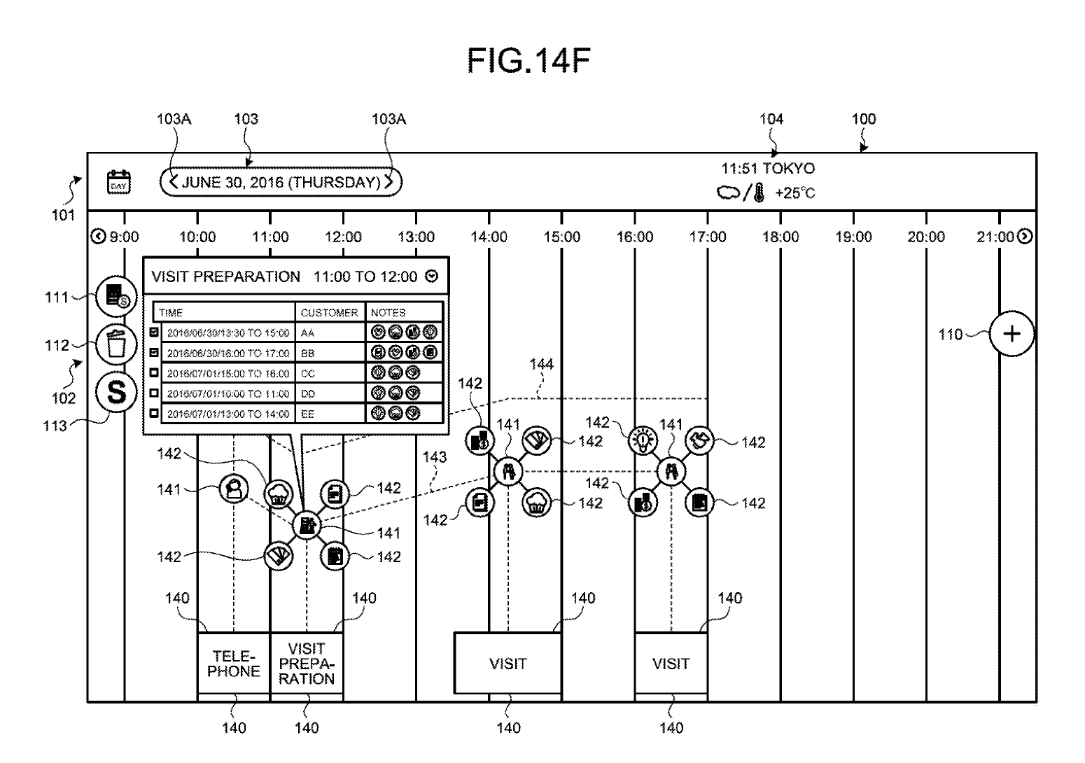

The display controller 50 performs, for each of the main tasks, weight addition on the number of processed results by adding thereto a predetermined weight according to a kind of the corresponding main task so as to calculate a result value of the corresponding main task. The display controller 50 controls to display past results at respective heights in accordance with the computed result values at positions of the same times as those of the icons 141 of the main tasks. The example illustrated in FIG. 13F indicates a line 144 that connects the past results at respective heights according to the result values. The display controller 50 may control to display the targeted values and the result values of tasks. FIG. 14A is a diagram illustrating a display example of the targeted value and the result value of the task. The example illustrated in FIG. 14A indicates the case where a targeted value and a result value of a main task is displayed.

The receiving unit 51 receives an operation for registering a generated cost with respect to a task registered in the schedule. The registering unit 52 registers, with respect to the task whose cost is registered, the registered cost in the item of cost in the task information 36. The receiving unit 51 receives an operation for process completion of the task registered in the schedule. The registering unit 52 registers “already done” in the item of process status of the task information 36 with respect to the task whose operation for process completion is received.

The receiving unit 51 may receive an input of information on execution of a task, such as a processed number of the task, with respect to the tasks registered in the schedule. When the information on execution of the task is input, the display controller 50 may update a remaining needed value up to the targeted value and may control to display the updated remaining needed value. FIG. 14B is a diagram illustrating a display example of the needed value of the task. The example illustrated in FIG. 14B indicates the case where a remaining needed value of a main task up to a targeted value is displayed.

The receiving unit 51 may receive setting of a goal by changing a height of the icon 141 of a main task displayed on the schedule screen 100. For example, a display position of the icon 141 of the task can be changed. When the height of the icon 141 of the task is changed, the registering unit 52 changes a target number of the task in accordance with the changed height, and registers the changed target number. For example, the registering unit 52 subtracts, from the changed targeted value, a predetermined weight according to a kind of the task whose targeted value is changed so as to derive a target number of the task, and registers the target number in the task information 36. When a targeted value of a main task attended by a sub task is changed, the registering unit 52 may register, in the task information 36, the changed targeted value as a target number of the main task.

When many sub tasks are associated with a main task and do not have an enough space to display the associated sub tasks around the main task, the display controller 50 displays a character or a mark by which presence/absence of an undisplayed task can be identified. FIG. 14C is a diagram illustrating a display example of the presence/absence of the undisplayed task. The example illustrated in FIG. 14C indicates the case where a mark 145, which indicates existence of an undisplayed sub task, is displayed with respect to a main task.

When the mark 145 is selected, the display controller 50 controls to display sub tasks. FIG. 14D is a diagram illustrating a display example of sub tasks. The example illustrated in FIG. 14D indicates the case where the icons 142 of attending sub tasks are displayed by using a balloon in association with a main task.

The display controller 50 may control to display the undisplayed sub tasks by moving the displayed sub tasks arranged around the main task. FIG. 14E is a diagram illustrating a display example of the sub tasks. The example illustrated in FIG. 14E indicates the case where undisplayed sub tasks are displayed by rotating the sub tasks around the main task.

The receiving unit 51 may receive a target customer for processing a task. For example, the receiving unit 51 receives a target customer for processing with respect to a main task registered in the schedule. For example, the display controller 50 reads, from the customer information 31, customers of which an insurance agent of a logged-in user ID has charge, and displays a customer list. The receiving unit 51 receives a target customer for processing from the customer list. The registering unit 52 registers, in the item of the customer ID in the main schedule information 34, a customer ID of the target customer for processing. The receiving unit 51 may receive registration of sub tasks for each of the target customers for processing. FIG. 14F is a diagram illustrating one example of the schedule screen. The example illustrated in FIG. 14F indicates the case where a plurality of customers is registered with respect to a main task for visit preparation, and customers registered in association with the icon 141 of a main task for visit preparation are displayed by using a balloon. An icon of a sub task registered as “notes” is displayed for each of the customers. For example, the receiving unit 51 receives registration of a sub task by moving the sub task to be added from the menu icon 110 to a position of “notes” while keeping a selected state thereof, and then canceling the selection. When a target customer of the sub task is specified, the registering unit 52 registers, for example, the sub task in the sub schedule information 35 for each of customer IDs of the target customers of the task.

Meanwhile, for example, an insurance agent registers and manages in some cases tasks such as a visit preparation to a customer, a visit to a customer, and a plan of a telephone call to a customer, and does not register a lunch, movement to a visit destination, a morning meeting, a daily report writing, etc. as tasks.

Therefore, in the present embodiment, a task, which can be automatically added, can be added to the schedule. For example, when performing addition of a task, which can be automatically added, to the schedule, the insurance agent selects the simulation icon 113 of the schedule screen 100.

When the receiving unit 51 receives a selecting operation of the simulation icon 113, the registering unit 52 performs addition of a task, which can be automatically added, to the schedule based on automatic addition task information 38. For example, the registering unit 52 determines for each of the registered tasks that can be automatically added, with reference to automatic addition task information 38, that a time having a time width needed by the task, which can be automatically added, can be reserved in allowed times zone and out of time zones corresponding to tasks registered in the schedule. When the time having the time width needed by the task, which can be automatically added, can be reserved out of the time zones corresponding to the tasks registered in the schedule, the registering unit 52 automatically registers the task, which can be automatically added, in the schedule. The registering unit 52 registers the task, which can be automatically added, in the main schedule information 34 and the task information 36 as a main task.

When the receiving unit 51 receives a selecting operation of the simulation icon 113, the registering unit 52 automatically adds a task for movement to the schedule. For example, when a task for visiting customer is registered in the schedule and a task for movement to an address of this customer is not registered before this task for visiting customer, the registering unit 52 automatically adds the task for movement to the address of this customer. When a task for visiting customer is registered in the schedule and thereafter a task for movement to an address of a work place where the insurance agent works is not registered, the registering unit 52 automatically adds the task for movement to the address of the work place. For example, the registering unit 52 specifies along the time addresses where respective main tasks are performed with respect to the main tasks registered in the schedule. In a task for visit according to the present embodiment, an address where the task is performed is specified as an address of a visit destination customer. The registering unit 52 specifies an address of the visit destination customer with reference to the customer information 31. In main tasks other than a visit, an address of a work place where an insurance agent works is specified as the address where the tasks are performed. The registering unit 5 specifies, with reference to the user information 30, an address of a work place where an insurance agent having a logged-in user ID works. The registering unit 52 determines, for each of the main tasks registered in the schedule, that there exists, before the corresponding main task, a task for movement to an address where the corresponding main task is performed. The registering unit 52 may set, as an address of a work place where an insurance agent having a user ID works, reference positions where the schedule is started and where the schedule is terminated, and may determine along the schedule that there exists a task for movement to an address of a visit destination customer before the task for visit and the task for movement to the address of the work place before the task for daily report. For example, the registering unit 52 determines along the schedule that there exists a task for movement from the reference position, where the schedule is started, to an address of a visit destination customer and there exists a task for movement from an address of a visit destination customer to the reference position where the schedule is terminated.

When there exists no task for movement, the registering unit 52 automatically registers the schedule of a task for movement to an address where a task is performed in order to perform the task for movement before the task. For example, the registering unit 52 specifies addresses of a movement source and a movement destination to search a movement route and a cost by using an external server that provides search services of movement routes, and registers a task for movement by using the searched movement route and cost. For example, the registering unit 52 uses, as an arrival time, a predetermined time before a start time of a task for visit (for example, before ten minutes), or uses, as an departure time, a predetermined time after an end time of a prior task of the task for visit (for example, after ten minutes) to search a movement route, and automatically registers a task for movement. The registering unit 52 registers, as a main task, each task for movement in the main schedule information 34 and the movement information 39.

The registering unit 52 may register a task for lunch after registration of a task for movement. For example, the registering unit 52 uses, as an arrival time, a predetermined time before a start time of a task for visit, or uses, as an departure time, a predetermined time after an end time of a prior task of the task for visit to search for a movement route, and automatically registers a task for movement. When a time having a time width needed by a task for lunch can be reserved out of a time zones corresponding to tasks registered in the schedule, the registering unit 52 may register a task for lunch.

Meanwhile, users have in some cases respective behavior characteristics in behaviors for the schedule. For example, in a case of a visit, some insurance agent has a behavior characteristic of moving to a visit destination immediately after completion of a prior task, and others have a behavior characteristic of arriving at a visit destination immediately before a start of the visit.

Therefore, the registering unit 52 may register a task in accordance with a behavior characteristic of a user or a set rule. For example, the registering unit 52, in accordance with a behavior characteristic of a user or a set rule, may register a task for movement closer to a scheduled completion time of a just prior task of a task for movement, or may register or control the task for movement closer to a scheduled start time of a just posterior task of the task for movement. The behavior characteristic of the user may be set by the user as a rule, or may be derived from the past schedule. For example, the registering unit 52 reads a past schedule of an insurance agent of a logged-in user ID from the main schedule information 34, and specifies a behavior characteristic of the insurance agent. The registering unit 52 may register a task for movement by using the specified behavior characteristic. For example, the registering unit 52 specifies at which timing a task for movement (for example, one month) is performed in a past predetermined period with respect to tasks before and after the task for movement. For example, the registering unit 52 obtains time intervals from tasks just prior to the respective tasks for movement to the tasks for movement, and further derives a frequency distribution of the time intervals by a predetermined time width (for example, five minutes). The registering unit 52 obtains time intervals from the tasks for movement to tasks just posterior to the respective tasks for movement, and further derives a frequency distribution of the time intervals by a predetermined time width. The registering unit 52 registers a task for movement so that a timing thereof is similar to a timing whose frequency is the highest. For example, when the frequency, at which a time interval from a task just prior to a task for movement to the task for movement is a time width of six to ten minutes, is the highest, the registering unit 52 uses, as a departure time, the time when any time (for example, median eight minutes) of six to ten minutes is elapsed from a termination time of the task just prior to the task for movement so as to register the task for movement. The registering unit 52 may specify, for each of the predetermined time zones, a behavior characteristic from past tasks for movement included in time zones, and may register a task for movement in accordance with the behavior characteristic of the corresponding time zone. The time zones may have the same time period, such as the one-hour time zones. It may be considered that the time zone is divided into a non-lunch time and a lunch time, for example, a time zone before twelve o'clock, a time zone from twelve o'clock to fourteen o'clock, a time zone after fourteen o'clock, etc. The registering unit 52 may specify a behavior characteristic from a past task for movement to the same address as that of a task for movement to be added, and may register a task for movement by using the specified behavior characteristic.

The registering unit 52 may control a movement route in accordance with a behavior characteristic of a user or a set rule so that the user moves by using transportation means whose use frequency in movement is high. For example, the registering unit 52 reads, with reference to the movement information 39, a past route whose addresses of a movement source and a movement destination are similar thereto, and derives a frequency for each of the used transportation means. When the addresses of a movement source and a movement destination are not completely coincide with the respective addresses of a past movement source and a past movement destination, a predetermined range such as in the same town is treated as the same. The registering unit 52 specifies the highest-frequency transportation means, an address of a movement source, and an address of a movement destination by using an external server that provides search services of movement routes, searches for a movement route and a cost thereof, and registers a task for movement by using the searched movement route and cost. Thus, a movement route is searched by using movement means frequently used in a movement from an address of the movement source to an address of the movement destination.

The registering unit 52 may search for, with respect to a task for lunch, a candidate restaurant for the lunch in accordance with a scheduled position at a time of the task for lunch, and may memorize, in the memory 21, information on the searched restaurant as lunch information in association with the task for lunch. For example, the registering unit 52 specifies a destination address of a task for movement before a task for lunch or a departure place address of a task for movement after the task for lunch as a scheduled position in a time of the task for lunch. The registering unit 52 specifies a scheduled position and a time of the task for lunch by using an external server that provides search services of restaurants, and searches for a restaurant locating near the specified position, whose opening hours includes the time of the task for lunch. The registering unit 52 may memorize, in the memory 21, an appellation of the searched restaurant, a position of the restaurant, a telephone number thereof, a menu thereof, etc. as the lunch information in association with the task for lunch. The registering unit 52 may search for a restaurant in accordance with a behavior characteristic of a user or a set rule, and may register a task for lunch. The behavior characteristic of the user may be preliminary set as a rule by the user, or may be derived from the past schedule. For example, the registering unit 52 reads, from the main schedule information 34, the past schedule of an insurance agent of a logged-in user ID, and specify a kind of a frequently used restaurant from lunch information associated with a task for lunch. The registering unit 52 may search for a restaurant locating near the specified position, whose opening hours includes the time of the task for lunch and whose kind is used most frequency by using an external server that provides search services of restaurants.

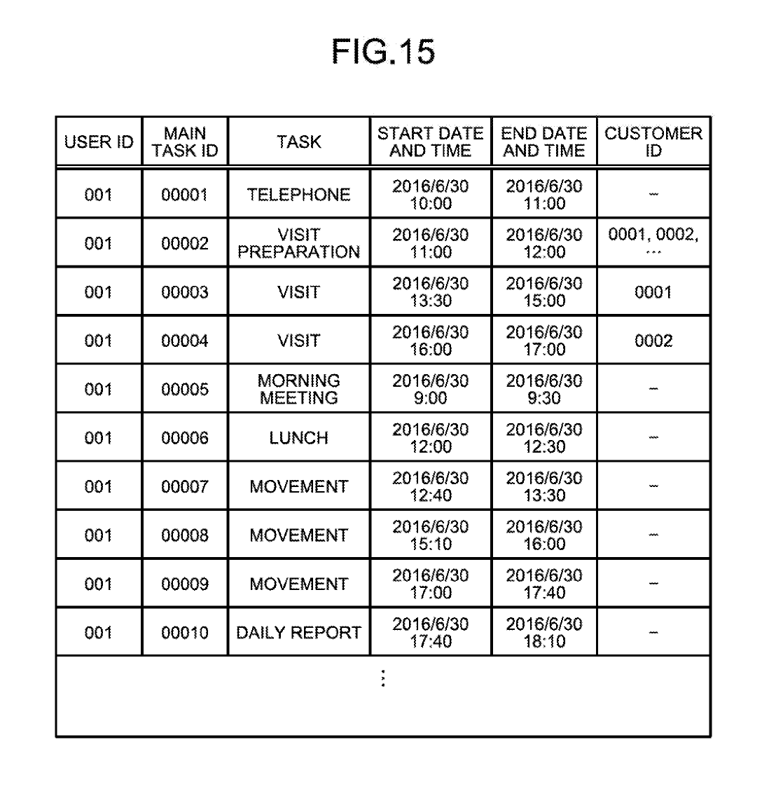

Thus, for example, in a case where automatic addition task information 38 is in a state illustrated in FIG. 11, when there exists an unoccupied time for thirty minutes in a time zone from nine o'clock to ten o'clock, a task for morning meeting is automatically added. When there exists an unoccupied time for thirty minutes in a time zone from twelve o'clock to fourteen o'clock, a task for lunch is automatically added. When there exists an unoccupied time for thirty minutes in a time zone from seventeen o'clock to nineteen o'clock, a task for daily report is automatically added. Moreover, tasks for movement are automatically added. FIG. 15 a diagram illustrating a data organization example of the main schedule information to which tasks are automatically added. The example illustrated in FIG. 15 indicates a state where tasks are automatically added to the state illustrated in FIG. 7.

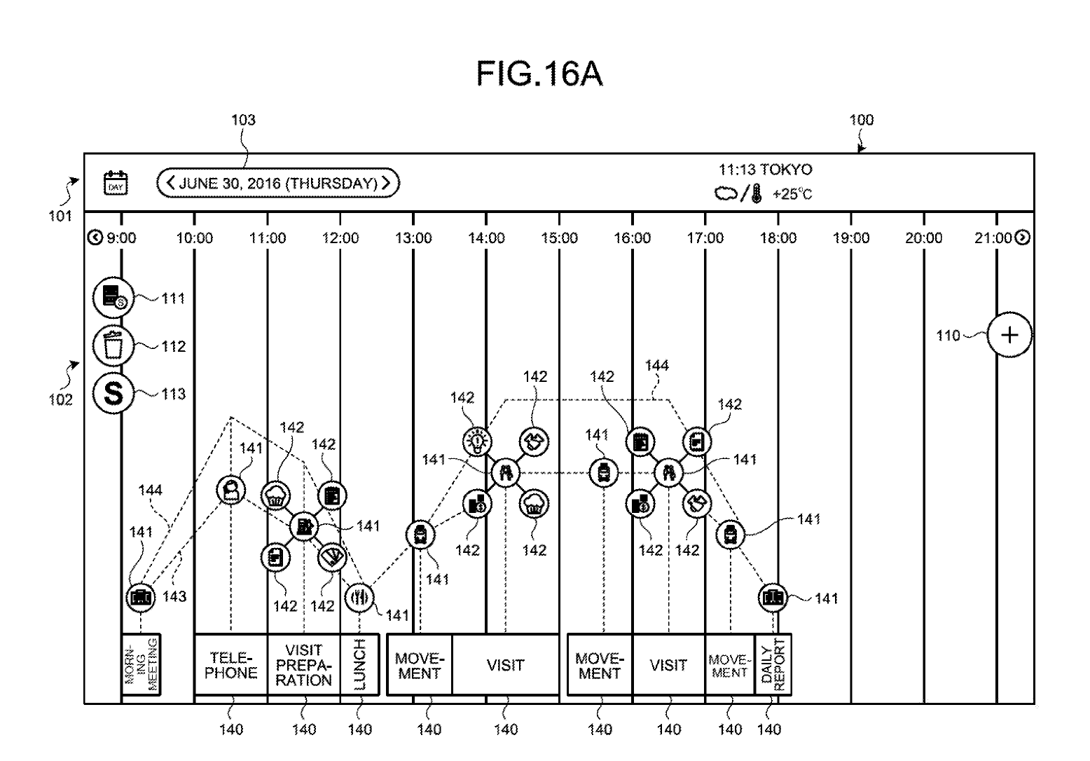

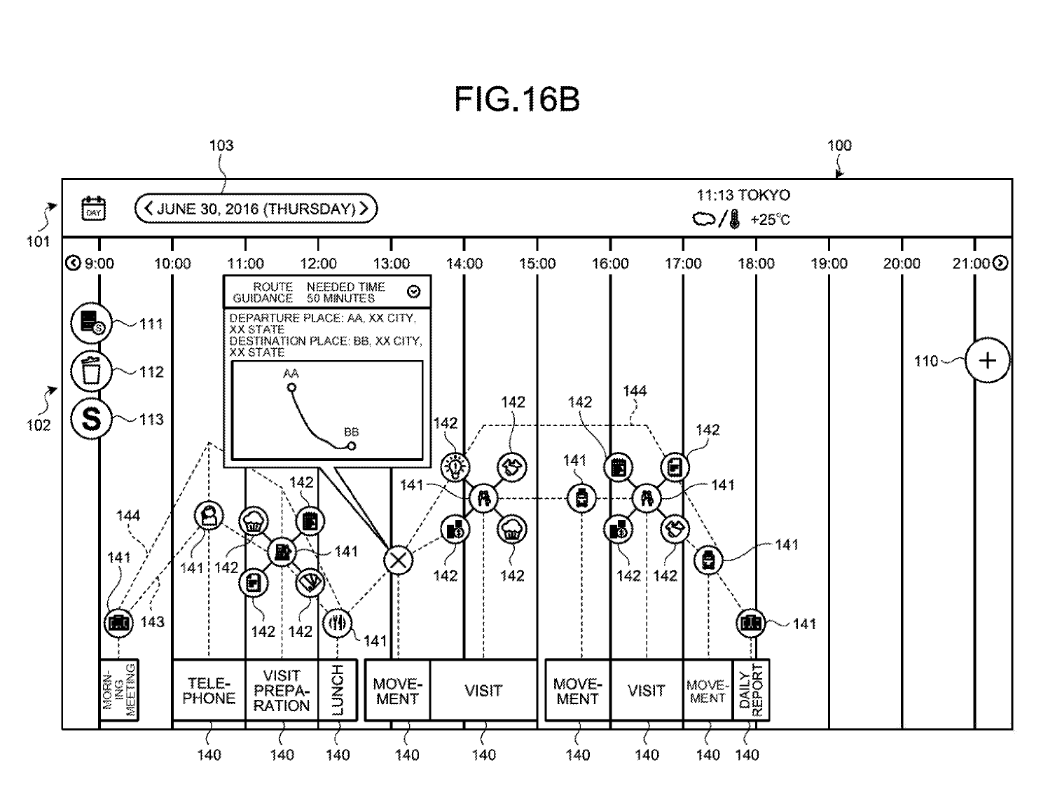

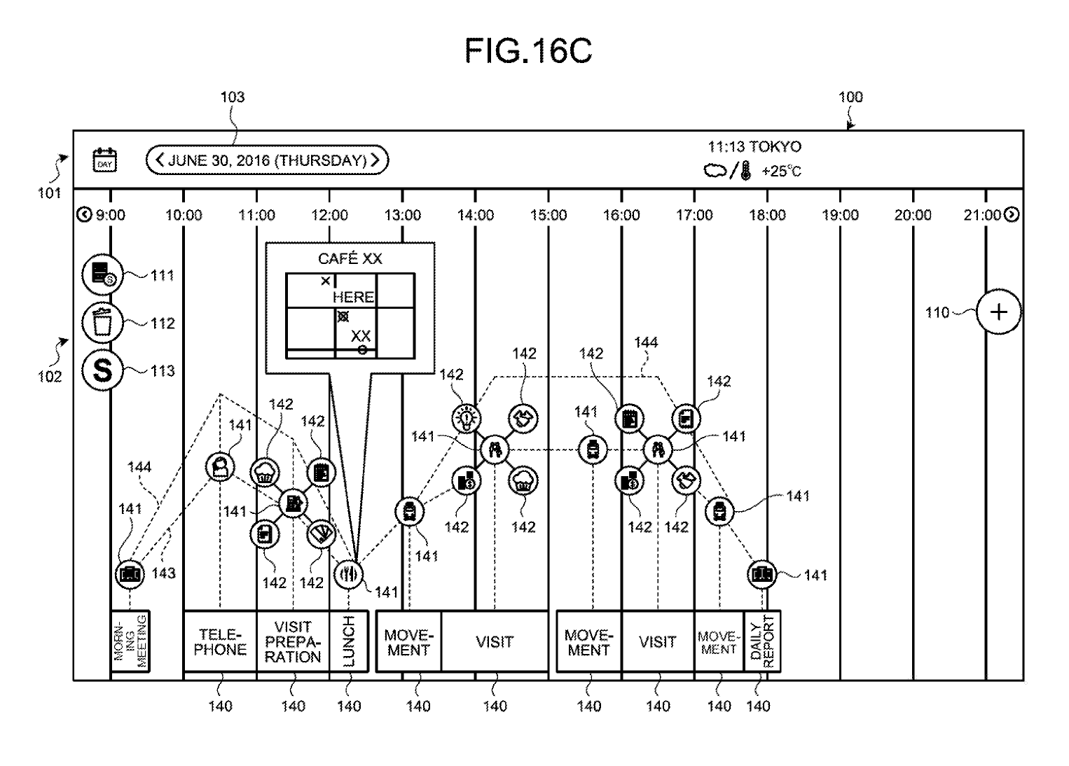

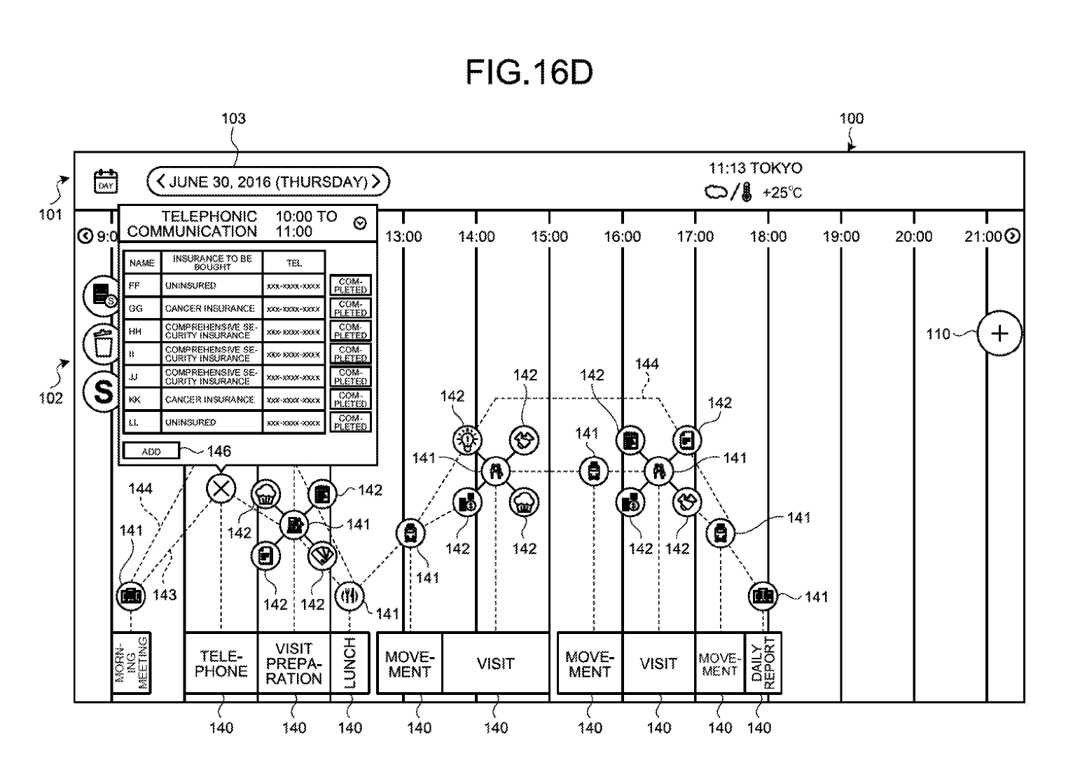

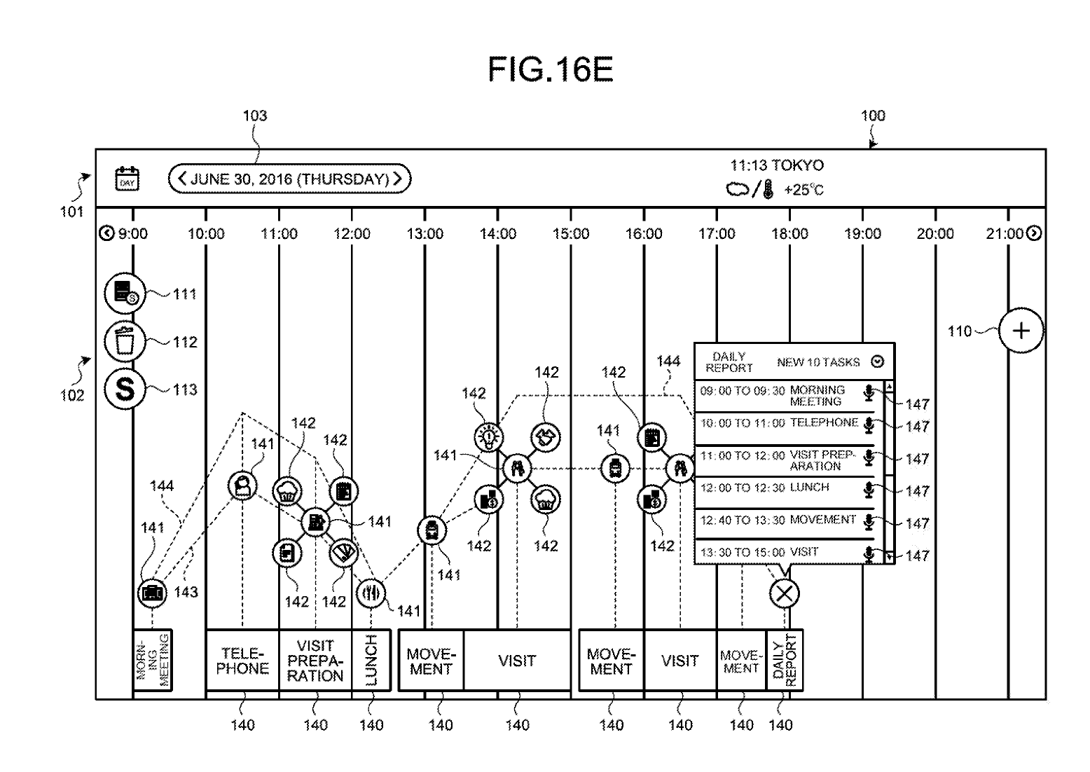

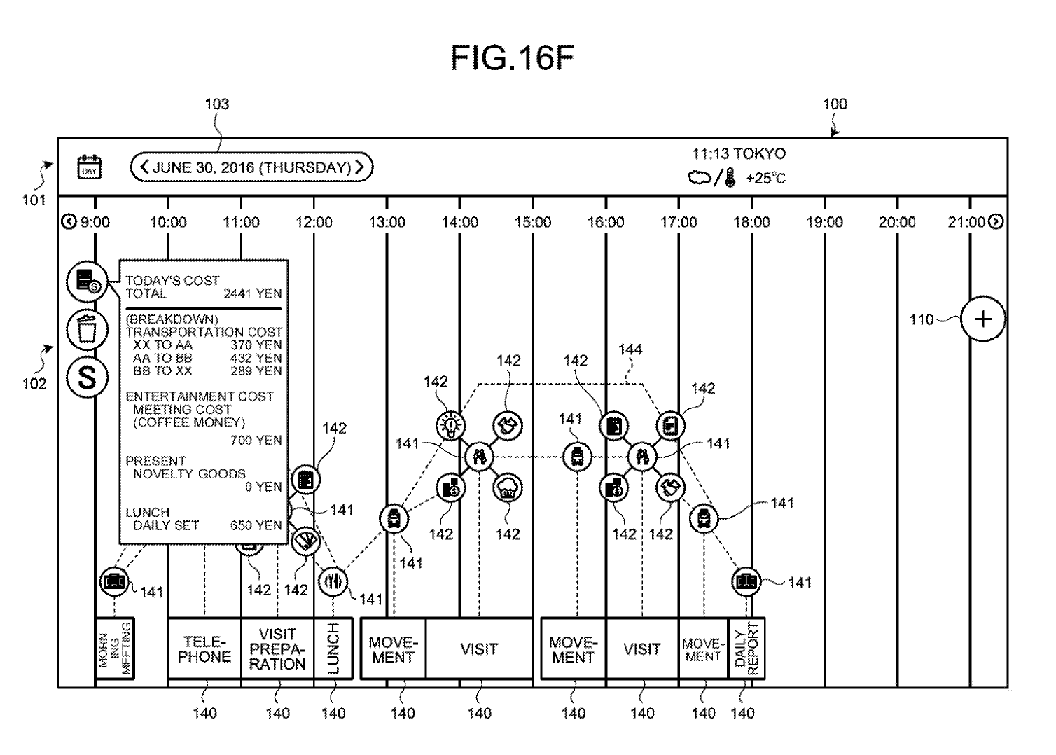

The display controller 50 controls to display a schedule including automatically added tasks on the schedule screen 100. FIG. 16A is a diagram illustrating one example of the schedule screen. In the example illustrated in FIG. 16A, the bars 140 and the icons 141 of tasks for morning meeting, lunch, daily report, and movement are added to the schedule from the state illustrated in FIG. 13F.

The receiving unit 51 receives a change of the start date and time and the end date and time of a task whose bar 140 is moved by turning the bar 140 into a selected state and moving the bar 140 of the task displayed on the schedule screen 100. When receiving the movement of the bar 140 of the task, the registering unit 52 changes the start date and time and the end date and time, which is memorized in the main schedule information 34, of the task whose bar 140 is moved in accordance with the time of a movement destination position. For example, when the bar 140 is changed into an earlier time position, the registering unit 52 uses the time corresponding to a beginning position of the bar 140 as a departure time to re-searches for a movement route, and changes the movement route of the task for movement. When the bar 140 is changed into a later time position, the registering unit 52 uses the time corresponding to an end position of the bar 140 as an arrival time to re-search for a movement route, and changes the movement route of the task for movement. When a time period of the moved task is overlapped with that of an automatically added task by the movement of the bar 140, the registering unit 52 may perform again registration of the automatically added task.

When a task icon displayed on the schedule screen 100 is selected, the display controller 50 controls to display various kinds of information on the task of the selected icon on the schedule screen 100.

For example, when the icon 141 of a task for movement is selected, the display controller 50 reads a movement route of the task for movement of the selected icon 141 from the movement information 39, and controls to display the movement route. FIG. 16B is a diagram illustrating one example of the schedule screen. The example illustrated in FIG. 16B indicates the case where a route map indicating a movement route in association with a task for movement is displayed by using a balloon.

For example, when the icon 141 of a task for lunch is turned into a selected state, the display controller 50 reads lunch information, which is associated with the task for lunch of the select icon 142, from the memory 21 and controls to display the lunch information. FIG. 16C is a diagram illustrating one example of the schedule screen. The example illustrated in FIG. 16C indicates the case where an appellation of a restaurant and a map indicating a position thereof is displayed by using a balloon in association with a task for lunch.

For example, when the icon 141 of a task for telephone is turned into a selected state, the display controller 50 displays information on a target customer on which an insurance agent of a logged-in user ID performs a telephonic communication on a schedule day. For example, the display controller 50 reads, from the telephonic communication information 32, customer IDs of target customers on which telephonic communications are to be performed by the insurance agent of the logged-in user ID on a scheduled day, insurances to be bought by the customer, and statuses of telephonic communications. The display controller 50 reads, from the customer information 31, customer names and telephone numbers corresponding to the respective customer IDs. The display controller 50 controls to display the customer names of the target customers on which telephonic communications are to be performed, the insurances to be bought by the customer, the telephone numbers thereof, and the statuses of the telephonic communications. FIG. 16D is a diagram illustrating one example of the schedule screen. The example illustrated in FIG. 16D indicates the case where customer names of target customers on which telephonic communications are to be performed, insurances to be bought by the customers, telephone numbers thereof, statuses of telephonic communications are displayed by using a balloon in association with the task for telephone. In the present embodiment, when an addition button 146 is selected, a target customer on which a telephonic communication is to be performed can be added.

For example, when the icon 141 of a task for daily report is turned into a selected state, the display controller 50 controls to display information that assists writing of a daily report. For example, the display controller 50 controls to display tasks registered in accordance with the schedule, the times of start dates and times of the tasks, and the times of end dates and times of the tasks. FIG. 16E is a diagram illustrating one example of the schedule screen. The example illustrated in FIG. 16E indicates the case where tasks registered in association with a task for daily report, the times of start dates and times of the respective tasks, and the times of end dates and times of the respective tasks are displayed by using a balloon. Sound input buttons 147 are provided in the respective tasks, and awareness in a conversation with a customer can be input by using sound. Contents input by using sound is converted into text by using the sound recognition, and is output by a predetermined operation along with display contents of each of the tasks displayed by using a balloon.

For example, when the icon 141 of a task for morning meeting is turned into a selected state, the display controller 50 controls to display messages of a message list of an insurance company, which is reported by a system of the company.

For example, when the cost icon 111 is turned into a selected state, the display controller 50 controls to display costs generated by respective tasks registered in the schedule. FIG. 16F is a diagram illustrating one example of the schedule screen. The example illustrated in FIG. 16F indicates the case where costs, which is generated by respective tasks registered in the schedule, are displayed by using a balloon in association with the cost icon 111. The costs generated by the respective tasks can be tallied for, for example, a week, a month, a year, etc. on another cost screen, and can be output as data that is available for the tax return.

In the present embodiment, among tasks registered in the schedule, a task of the date and time before the present date and time is treated as a result. An insurance agent can register the result by moving and correcting each of the tasks registered in the schedule. Each of the tasks registered in the schedule may be moved or corrected from the user terminal 11 of the insurance agent based on position information. For example, the acquiring unit 53 acquires the position information from the user terminal 11 of an insurance agent. The registering unit 52 may move or correct each of the tasks registered in the schedule based on the acquired position information. For example, the registering unit 52 may move or correct a task for movement based on the acquired position information.

Processing Procedures

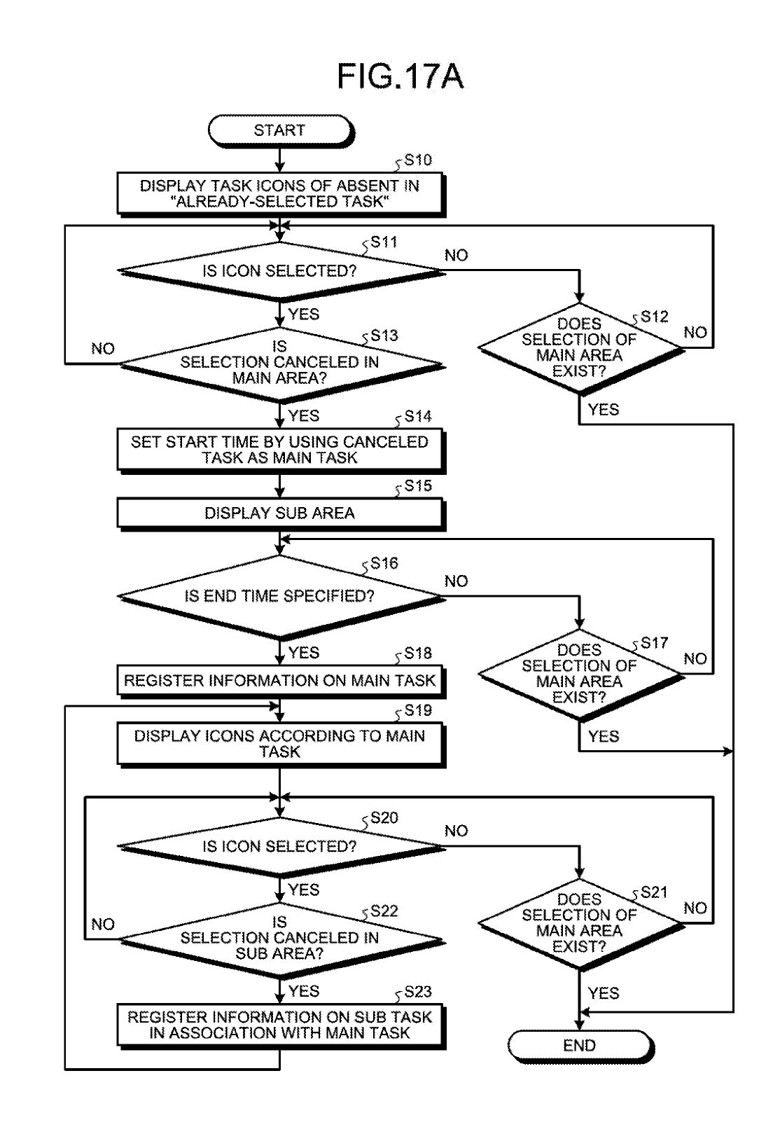

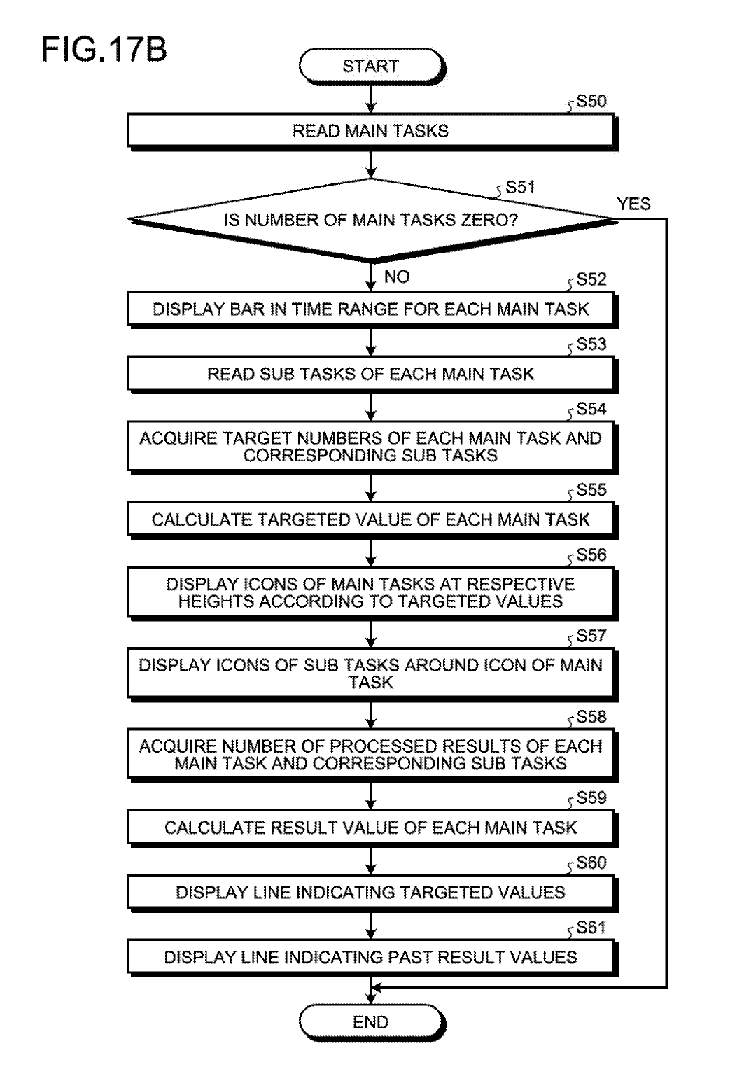

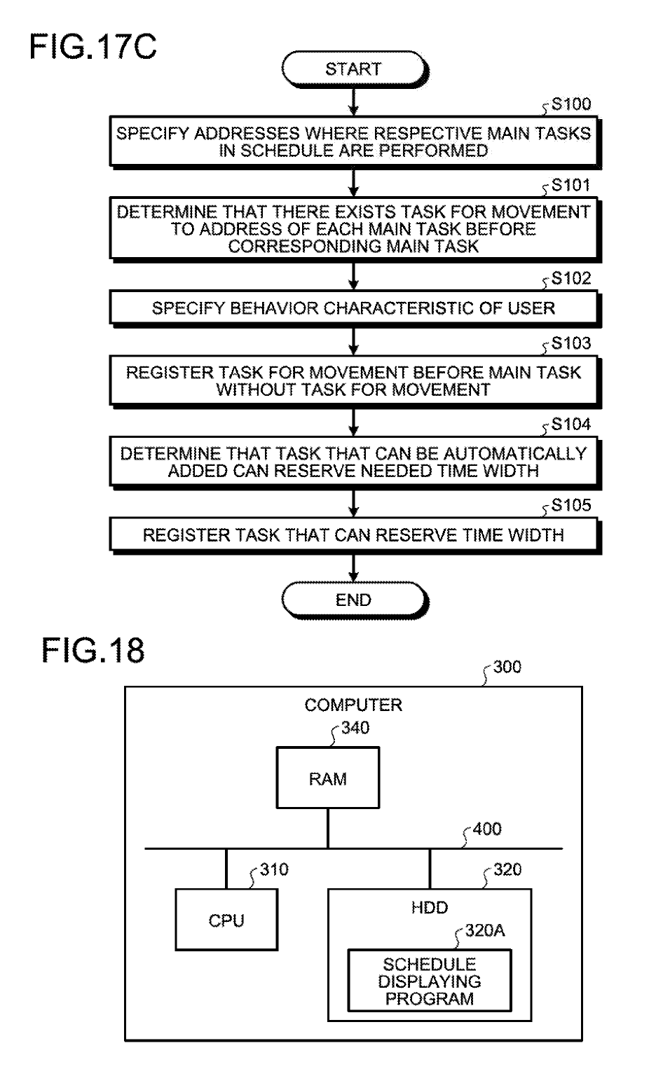

Next, various processing procedures executed by the server apparatus 12 according to the present embodiment will be explained. First, a processing procedure for task registering processes, in which the server apparatus 12 receives registration of a task in the schedule, will be explained. FIG. 17A is a flowchart illustrating the processing procedure for the task registering processes. The task registering processes illustrated in FIG. 17A are executed at a predetermined timing that is, for example, a timing at which a selecting operation to the menu icon 110 of the schedule screen 100 is received.

The display controller 50 reads tasks whose items of already-selected tasks are “absent” from the menu information 33, and displays the icons 120 indicating the respective read tasks around the menu icon 110 in accordance with the order thereof (Step S10).

The receiving unit 51 determines whether or not a selecting operation of the icon 120 is received (Step S11). When not receiving the selecting operation of the icon 120 (Step S11: No), the receiving unit 51 determines whether or not a selecting operation of the main area 102 is received (Step S12). When the selecting operation of the main area 102 is received (Step S12: Yes), the process is terminated.

On the other hand, when the selecting operation of the main area 102 is not received (Step S12: No), the process is shifted to aforementioned Step S11.

On the other hand, when receiving the selecting operation of the icon 120 (Step S11: Yes), the receiving unit 51 determines whether or not the selection of the selected icon 120 is canceled in the main area 102 (Step S13). When the selection of the selected icon 120 is not canceled in the main area 102 (Step S13: No), the process is shifted to aforementioned Step S11.

On the other hand, when the selection of the selected icon 120 is canceled in the main area 102 (S13: Yes), the receiving unit 51 uses a task of the icon 120 whose selection is canceled as a main task, and specifies the time corresponding to a position where the selection is canceled as a start time of the main task (Step S14).

The display controller 50 controls to display the sub area 105 in a lower half part of the main area 102 (Step S15). The receiving unit 51 determines whether or not specifying of an end time of the main task is received in the sub area 105 (Step S16). When not receiving the specifying of the end time (Step S16: No), the receiving unit 51 determines whether or not a selecting operation of the main area 102 is received (Step S17). When the selecting operation of the main area 102 is received (Step S17: Yes), the process is terminated.

On the other hand, when the selecting operation of the main area 102 is not received (Step S17: No), the process is shifted to the aforementioned Step S16.

On the other hand, when receiving the specifying of the end time (Step S16: Yes), the registering unit 52 gives a unique task ID to the main task, and registers information on the main task in the main schedule information 34 and the task information 36 (Step S18).

The display controller 50 reads tasks whose item of the already-selected task are similar to the main task from the menu information 33, and displays the icons 130 indicating the read tasks around the menu icon 110 in accordance with the order thereof (Step S19).

The receiving unit 51 determines whether or not a selecting operation of the icon 130 is received (Step S20). When not receiving the selecting operation of the icon 130 (Step S20: No), the receiving unit 51 determines whether or not a selecting operation of the main area 102 is received (Step S21). When the selecting operation of the main area 102 is not received (Step S21: Yes), the process is terminated.

On the other hand, when the selecting operation of the main area 102 is not received (Step S21: No), the process is shifted to the aforementioned Step S20.

On the other hand, when receiving the selecting operation of the icon 130 (Step S20: Yes), the receiving unit 51 determines whether or not a selection of the selected icon 130 is canceled in the sub area 105 (Step S22). When the selection of the selected icon 130 is not canceled in the sub area 105 (Step S22: No), the process is shifted to the aforementioned Step S20.

On the other hand, when the selection of the selected icon 130 is canceled in the sub area 105 (Step S22: Yes), the registering unit 52 uses a task of the icon 130 as a sub task to give thereto a unique task ID, registers information on the sub task in the sub schedule information 35 and the task information 36 in association with the task ID of the main task (Step S23), and shifts the process to the aforementioned Step S19.

Next, a processing procedure for displaying processes, in which the server apparatus 12 displays the schedule in which tasks are registered, will be explained. FIG. 17B is a flowchart illustrating a processing procedure for schedule displaying processes. The displaying processes illustrated in FIG. 17B is executed at a predetermined timing that is, for example, a timing at which a selecting operation of the main area 102 on the schedule screen 100 is received.

The display controller 50 reads, from the main schedule information 34, main tasks whose start dates and times or end dates and times includes the date of the date area 103 (Step S50). The display controller 50 determines whether or not the number of the read main tasks is zero (Step S51). When the number of the main tasks is zero (Step S51: Yes), the process is terminated.

On the other hand, when the number of the main tasks is not zero (Step S51: No), the display controller 50 controls to display, for each of the main tasks, the bar 140 in a time range of the main area 102 corresponding to the start date and time and the end date and time of the corresponding main task (Step S52).

The display controller 50 reads sub tasks attending each of the main tasks from the sub schedule information 35 (Step S53).

The acquiring unit 53 acquires, from the task information 36, the target number of each of the main tasks and the target numbers of the respective sub tasks associated with the corresponding main task (Step S54). The display controller 50 performs, for each of the main tasks, weight addition on the target number of the corresponding main task by adding thereto a predetermined weight according to a kind of the corresponding main task so as to calculate a targeted value of the corresponding main task (Step S55). The display controller 50 controls to display the icons 141 of the main tasks at respective heights according to the computed targeted values in association with the bars 140 of the main tasks (Step S56). When there exist the sub tasks attending the main task, the display controller 50 controls to display the icons 142 of the respective attending sub tasks around the icon 141 of the main task (Step S57).

The acquiring unit 53 acquires from the comparison result information 37, for each of the main tasks, the number of processed results that is a comparison target of the corresponding main task and the number of processed results that is a comparison target of the sub task associated with the corresponding main task (Step S58).

The display controller 50 performs, for each of the main tasks, weight addition on the number of processed results by adding thereto a predetermined weight according to a kind of the corresponding main task so as to calculate a result value of the corresponding main task (Step S59).

The display controller 50 controls to display the line 143 indicating the targeted values, which connects the icons 141 of the main tasks at respective heights according to the targeted values (Step S60). The display controller 50 controls to display the line 144 indicating the past results, which connects the past results at respective heights according to the computed result values, at the same time position as that of the icons 141 of the main tasks (Step S61), and terminates the process. As illustrated in FIG. 14A, the display controller 50 may control to display a targeted value and a result value for each of the main tasks. As illustrated in FIG. 14B, the display controller 50 may control to display a remaining needed value up to the targeted value for each of the main tasks.

Next, a processing procedure for automatic registering processes, in which the server apparatus 12 automatically registers a task in the schedule, will be explained. FIG. 17C is a flowchart illustrating a processing procedure for automatic registering processes. The automatic registering processes illustrated in FIG. 17C is executed at a predetermined timing that is, for example, a timing at which a selecting operation of the simulation icon 113 is received.

The registering unit 52 specifies along the time addresses where the respective main tasks are performed with respect to the main tasks registered in the schedule (Step S100). A task for visit specifies an address where the task is performed as an address of a visit destination customer. In main tasks other than a task for visit, an address of the work place where an insurance agent works is specified as an address where the tasks are performed.

The registering unit 52 determines, for each of the main tasks registered in the schedule, that there exists, before the corresponding main task, a task for movement to an address where the corresponding main task is performed (Step S101).

The registering unit 52 reads, from the main schedule information 34, a past schedule of the insurance agent of the logged-in user ID, and specifies a behavior characteristic of the insurance agent (Step S102).

When there exists a main task without a task for movement, the registering unit 52 registers in the schedule, before this main task, a task for movement to an address where this main task is performed in accordance with the behavior characteristic of the user (Step S103).

The registering unit 52 determines for each of the registered tasks that can be automatically added, with reference to the automatic addition task information 38, a time whose time width is needed by the corresponding task that can be automatically added can be reserved in an allowed time zone and out of a time zone corresponding to the task registered in the schedule (Step S104). When the time having the time width needed by the task that can be automatically added can be reserved, the registering unit 52 automatically registers the task that can be automatically added in the main schedule information 34 and the task information 36 as the main task (Step S105), and terminates the process.

Effects

The server apparatus 12 according to the embodiment registers, in a schedule, a specific task selected from among a plurality of kinds of tasks by using the menu icon 110 on the schedule screen 100. The server apparatus 12 acquires, with reference to the memory 21 that memorizes, in association with the tasks, targeted values and past result values on performance of the tasks, a targeted value and a past result value, which correspond to the registered specific task, associated with performance of the specific task. The server apparatus 12 displays, when displaying the schedule including the registered specific task, the schedule along with the acquired target and past result values. For example, the server apparatus 12 display the line 143 indicating the targeted values, which connects the icons 141 of the main tasks at respective heights according to the targeted values. The server apparatus 12 displays the line 144 indicating the past results, which connects the past results at respective heights according to the result values of the main tasks, at the same time position as that of the icons 141 of the main tasks. Thus, the server apparatus 12 can present working levels of the registered tasks so that the working levels can be easily grasped.

The server apparatus 12 according to the embodiment updates a remaining needed value up to the targeted value in association with the specific task registered in the schedule, and displays the updated remaining needed value when information on the performance of the specific task is further input. For example, as illustrated in FIG. 14B, the server apparatus 12 displays the remaining needed value up to the targeted value for each of the main tasks. Thus, the server apparatus 12 can present the remaining needed values up to the respective targeted values so that the remaining needed values can be easily grasped.

The server apparatus 12 according to the embodiment selects the specific task from among the plurality of kinds of tasks by using a selecting menu of the plurality of kinds of tasks. Thus the server apparatus 12 can present a task so that the presented task can be easily selected.

The server apparatus 12 according to the embodiment displays a mark corresponding to the specific task at a position corresponding to the targeted value. Thus, the server apparatus 12 can present the targeted value of the specific task at the height of the mark so that the presented targeted value can be easily grasped.

The position of the mark can be changed into a display position corresponding to a value that is different from the targeted value, and the server apparatus 12 according to the embodiment changes the targeted value corresponding to the specific task in accordance with the change of the display position. Thus, in the server apparatus 12, the user can easily change the targeted value corresponding to the specific task.

The server apparatus 12 according to the embodiment displays a schedule bar that displays an appellation corresponding to the specific task in association with the bar 140 that is located at a position and has a length corresponding to a time zone registered in accordance with the specific task. Thus, in the server apparatus 12, the appellations of the time zone and the task registered in association with the specific task can be easily grasped by a user by using the bar 140.

The server apparatus 12 according to the embodiment receives a registration of a task (for example, sub task) in association with the specific task (for example, main task). The server apparatus 12 arranges and displays a mark corresponding to the registered task around the mark corresponding to the specific task. Thus, the server apparatus 12 can present the task registered in association with the specific task so that the task can be easily grasped.

### [b] Second Embodiment

Meanwhile, the embodiment associated with the disclosed apparatus has been explained. However, the disclosed technology may be worked in various different kinds of modes other than that explained in the aforementioned embodiment. Therefore, other embodiments included in the present disclosure will be explained, hereinafter.

For example, in the aforementioned embodiment, the case in which an insurance agent as a user manages a schedule is explained as an example. However, the user is not limited to the insurance agent.

In the aforementioned embodiment, the case in which a schedule is displayed in a manner of expressing the time flow in a lateral direction and expressing the targeted values and the past result values in a vertical direction is explained as an example. However, is not limited thereto. For example, the schedule may be displayed in a manner of expressing the time flow in the vertical direction and expressing the targeted values and the past result values in the lateral direction. Moreover, a schedule that expresses any one of the targeted value and the result value of the task may be displayed.

In the aforementioned embodiment, the case in which colors of marks corresponding to respective tasks are the same is explained as an example. However, is not limited thereto. For example, the color of each of the marks corresponding to the respective tasks may be changed in accordance with a kind of the corresponding task. Colors of the marks corresponding to tasks that are, for example, tasks associated with a customer such as a visit to a customer, tasks associated with a user such as a morning meeting and a daily report, tasks that are automatically added, etc. may be changed.

In addition, each component of each apparatus illustrated in the drawings is functionally conceptual, and thus, does not always physically configured as illustrated in the drawings. Namely, a specific mode of separation or integration of each apparatus is not limited to that illustrated in the drawings. That is, all or some of the components can be configured by separating or integrating them functionally or physically in any unit, according to various types of loads, the status of use, etc. For example, any processing units of the display controller 50, the receiving unit 51, the registering unit 52, and the acquiring unit 53 may be properly separated or integrated. The display controller 50, the receiving unit 51, the registering unit 52, and the acquiring unit 53 may be executed separately by a plurality of server apparatuses. The whole or arbitrary part of the display controller 50, the receiving unit 51, the registering unit 52, and the acquiring unit 53 may be executed by a Central Processing Unit (CPU) and a program that is analyzed and executed by the CPU and the like, or hardware by the wired logic.

Schedule Displaying Program

The various processes explained in the aforementioned embodiment may be realized by executing a prepared program by using a computer system such as a personal computer and a workstation. Hereinafter, one example of the computer system, which executes the program including functions similar to those of the aforementioned embodiment, will be explained. FIG. 18 is a diagram illustrating the computer that executes a schedule displaying program.

As illustrated in FIG. 18, a computer 300 includes a CPU 310, a Hard Disk Drive (HDD) 320, and a Random Access Memory (RAM) 340. The units 310 to 340 are connected with each other through a bus 400.

In the HDD 320, a schedule displaying program 320A is preliminary memorized that exerts functions similar to those of each process unit of the server apparatus 12 according to the aforementioned embodiment. For example, the schedule displaying program 320A is memorized, which exerts functions similar to those of the display controller 50, the receiving unit 51, the registering unit 52, and the acquiring unit 53 according to the aforementioned embodiment. The schedule displaying program 320A may be appropriately separated.

The HDD 320 memorizes various data. For example, the HDD 320 memorizes an Operating System (OS) and various data.

The CPU 310 reads the schedule displaying program 320A from the HDD 320, and executes the read schedule displaying program 320A to perform operations similar to those of the display controller 50, the receiving unit 51, the registering unit 52, and the acquiring unit 53 according to the embodiment. Namely, the schedule displaying program 320A performs the operations similar to those of the display controller 50, the receiving unit 51, the registering unit 52, and the acquiring unit 53 according to the embodiment.

The aforementioned schedule displaying program 320A is not needed to be preliminary memorized in the HDD 320. For example, the program may be memorized in “portable physical medium” such as a Flexible Disk (FD), a Compact Disk Read Only Memory (CD-ROM), a Digital Versatile Disk (DVD), an optical disk, and an Integrated Circuit card (IC card), which are inserted into the computer 300. The computer 300 may read the program therefrom to execute the read program.

Furthermore, the program may be memorized in “another computer (or server)” and the like that is connected with the computer 300 through the public line, the Internet, a Local Area Network (LAN), a Wide Area Network (WAN), etc. The computer 300 may read the program therefrom to execute the read program.

According to an aspect of the embodiments, the working levels of the registered tasks can be presented so as to be easily grasped.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing a schedule displaying program that causes a computer to execute a process comprising:
registering, in a schedule, a specific task selected from among a plurality of kinds of tasks;
acquiring, with reference to a memory that memorizes targeted values and past result values on performance of the tasks in association with the tasks, a targeted value and a past result value on performance of the specific task registered in the registering, the targeted value and the past result value corresponding to the specific task; and
displaying, when displaying the schedule including the registered specific task, the schedule along with the targeted value and the past result value acquired in the acquiring.

2. The non-transitory computer-readable recording medium according to claim 1, wherein the process further includes updating a remaining needed value up to the targeted value in association with the specific task registered in the schedule and displaying the updated remaining needed value when information on the performance of the specific task is input.

3. The non-transitory computer-readable recording medium according to claim 1, wherein
the process further includes selecting the specific task from among the plurality of kinds of tasks, and
the selecting includes selecting the specific task from a selecting menu of the plurality of kinds of tasks displayed in association with the respective targeted values and/or the respective past result values.

4. The non-transitory computer-readable recording medium according to claim 1, wherein the displaying includes displaying the schedule in which a time flow is expressed in one direction of vertical and lateral directions and one or both of the targeted values and the past result values are expressed in another direction of the vertical and lateral directions.

5. The non-transitory computer-readable recording medium according to claim 1, wherein the displaying includes displaying a mark corresponding to the specific task at a position corresponding to the targeted value.

6. The non-transitory computer-readable recording medium according to claim 5, wherein
a position of the mark is able to be changed into a display position corresponding to a value that is different from the targeted value, and
the process further includes changing the targeted value corresponding to the specific task in accordance with a change of the display position.

7. The non-transitory computer-readable recording medium according to claim 1, wherein the displaying includes displaying, in association with an appellation corresponding to the specific task, a schedule bar including a position and a length corresponding to a time zone registered in association with the specific task.

8. The non-transitory computer-readable recording medium according to claim 5, wherein
the registering includes registering a task in association with the specific task, and
the process further includes arranging and displaying a mark corresponding to the registered task around the mark corresponding to the specific task.

9. The non-transitory computer-readable recording medium according to claim 5, wherein the displaying includes deciding a color of the mark corresponding to the specific task in accordance with a kind of the specific task.

10. A schedule displaying method comprising:
registering, in the schedule, a specific task selected from among a plurality of kinds of tasks, by a processor;
acquiring, with reference to a memory that memorizes targeted values and past result values on performance of the tasks in association with the tasks, a targeted value and a past result value on performance of the specific task registered in the registering, the targeted value and the past result value corresponding to the specific task, by the processor; and
a displaying, when displaying the schedule including the registered specific task, the schedule along with the targeted value and the past result value acquired in the acquiring, by the processor.

11. A schedule displaying apparatus comprising:
a processor configured to:
register, in a schedule, a specific task selected from among a plurality of kinds of tasks;
acquire, with reference to a memory that memorizes targeted values and past result values on performance of the tasks in association with the tasks, a targeted value and a past result value on performance of the specific task registered, the targeted value and the past result value corresponding to the specific task; and
control, when displaying the schedule including the registered specific task, to display the schedule along with the targeted value and the past result value acquired.
